(19) United States
(12) Patent Application Publication
(10) Pub. No.: US 2024/0262965 A1
(43) Pub. Date: Aug. 8, 2024

(54) MULTICOMPONENT CURABLE COMPOSITION AND UTILIZATION THEREOF

(71) Applicant: KANEKA CORPORATION, Osaka (JP)

(72) Inventor: Hiroshi Kamiyama, Hyogo (JP)

(73) Assignee: KANEKA CORPORATION, Osaka (JP)

(21) Appl. No.: 18/633,834

(22) Filed: Apr. 12, 2024

Related U.S. Application Data
(63) Continuation of application No. PCT/JP2022/037646, filed on Oct. 7, 2022.

(30) Foreign Application Priority Data
Oct. 19, 2021 (JP) 2021-171126

(51) Int. Cl. C08G 77/42; B05D 7/00; C08K 3/013; C09D 5/00; C09D 7/61

(52) U.S. Cl. CPC C08G 77/42; B05D 7/52; C08K 3/013; C09D 5/00; C09D 7/61

(57) ABSTRACT

A multi-component type curable composition that is capable of providing a cured product having an improved residual tackiness after one day is provided. The multi-component type curable composition contains an agent A that contains a specific polyoxyalkylene-based polymer (A) having a reactive silicon group and a specific epoxy resin curing agent (B), and an agent B that contains an epoxy resin (C).

### TECHNICAL FIELD

One or more embodiments of the present invention relate to a multi-component type curable composition, and a cured product and a waterproofing material which use the multi-component type curable composition. One or more embodiments of the present invention also relate to a method for producing a waterproof construction which uses the multi-component type curable composition.

### BACKGROUND

In a waterproofing membrane coating material used in a construction industry, often used is a two-component type urethane waterproofing membrane coating material in which a polyol resin (resin component) is used as a base resin and polyisocyanate is used as a curing agent (crosslinking agent). However, polyisocyanate is highly toxic and has a significant adverse effect on environment. For this reason, there has been a demand for a material that can be an alternative to the polyisocyanate.

As a material that can be an alternative to the polyisocyanate, for example, Patent Literature 1 discloses a curable composition that is obtained by mixing specific amounts of a reactive silicon group-containing polyoxyalkylene-based polymer, a (meth)acrylic acid alkyl ester-based copolymer, (C) an epoxy group-containing compound, and (D) a tertiary amine-based compound that does not contain a hydroxy group.

### PATENT LITERATURE

[Patent Literature 1]

### Japanese Patent Application Publication Tokukai No. 2004-315702

Although the above-described technology is excellent, there has been room for improvement in terms of residual tackiness.

### SUMMARY

In light of the above, an aspect of one or more embodiments of the present invention is to provide a multi-component type curable composition that is capable of providing a cured product having an improved residual tackiness after one day.

The inventor of one or more embodiments of the present invention made diligent studies and as a result, first found the following: it is possible to obtain, by mixing a specific epoxy resin curing agent with respect to a multi-component type curable composition which contains a specific polyoxyalkylene-based polymer and a specific epoxy resin, a multi-component type curable composition which is capable of providing a cured product having an improved residual tackiness after one day. Consequently, the inventor of one or more embodiments of the present invention has achieved one or more embodiments of the present invention.

An aspect of one or more embodiments of the present invention is a multi-component type curable composition (hereinafter, referred to as “the present multi-component type curable composition”) including: an agent A that contains a polyoxyalkylene-based polymer (A) having a reactive silicon group represented by general formula (1) and an epoxy resin curing agent (B) represented by general formula (2); and an agent B that contains an epoxy resin (C),

—Si(R)₃₋ₐ(X)ₐ (1)

where: each R independently represents a C1 to C20 hydrocarbon group or a triorganosiloxy group represented by —OSi(R′)₃ (where each R′ independently represents a C1 to C20 hydrocarbon group), and the hydrocarbon group represented as R may be subjected to substitution and has a hetero-containing group; each X independently represents a hydroxy group or a hydrolyzable group; and a represents an integer of 1 to 3, and

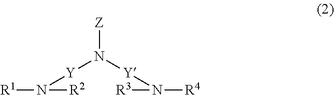

where: Z represents hydrogen, an N-containing alkyl group represented by general formula (3) below, or a C2 or higher straight-chain or branched alkyl group; R¹ to R⁴ each independently represent a straight-chain or branched alkyl group; and Y and Y′ each independently represent a straight-chain or branched alkylene group,

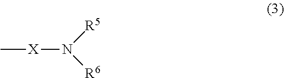

where: X represents a straight-chain or branched alkylene group; and R⁵ and R⁶ each independently represent a straight-chain or branched alkyl group.

An aspect of one or more embodiments of the present invention can provide a multi-component type curable composition that is capable of providing a cured product having an improved residual tackiness after one day.

### DETAILED DESCRIPTION

The following description will discuss one or more embodiments of the present invention in detail. Note that in the present specification, the wording “A to B” indicative of a numerical range means “A or more and B or less” unless otherwise specifically mentioned. In addition, all of the literatures listed herein are incorporated by reference herein.

### [1. Outline of One or More Embodiments of Present Invention]

As waterproofing membrane coating materials, inexpensive two-component urethane products (containing residual isocyanate) are commonly used. However, because of environmental regulations, a shift to non-isocyanate products has been required. As a material alternative to polyisocyanate, for example, Patent Literature 1 discloses a technology related to a curable composition containing a reactive silicon group-containing polyoxyalkylene-based polymer. However, studies on physical properties of the curable composition, for example, residual tackiness, have not been sufficiently made. As a result of diligent studies in terms of residual tackiness of the curable composition, the inventor of one or more embodiments of the present invention found that there was room for improvement in the residual tackiness after one day. Specifically, a cured product obtained by curing a conventional curable composition had a residual tackiness after one day. Accordingly, it was impossible to walk on the cured product until the cured product became no longer tacky (for example, until an interval of not less than 2 days elapsed). It was thus found that in workability, a next task could not be carried out.

In light of the above, the inventor of one or more embodiments of the present invention made diligent studies, and obtained the following findings.
By mixing a specific epoxy resin curing agent with respect to a multi-component type curable composition that contains a specific polyoxyalkylene-based polymer and a specific epoxy resin, it is possible to obtain a multi-component type curable composition that is capable of providing a cured product having an improved residual tackiness after one day.
The cured product thus obtained is also excellent in tensile properties and in tear strength.

Therefore, according to an aspect of one or more embodiments of the present invention, it is possible to provide a multi-component type curable composition that is capable of providing a cured product having an improved residual tackiness after one day. As such, an aspect of one or more embodiments of the present invention has an advantage that workability can be improved by a shortened construction period. In addition, according to an aspect of one or more embodiments of the present invention, it is possible to provide the present multi-component type curable composition that is excellent in tensile properties and in tear strength.

As described above, according to a feature in accordance with an aspect of one or more embodiments of the present invention, it is possible to provide, without use of a highly toxic isocyanate, a multi-component type curable composition that is capable of providing a cured product having the above-described advantages. This makes it possible to contribute to achieving, for example, Sustainable Development Goals (SDGs) such as Goal 12 “Ensure sustainable consumption and production patterns” and Goal 11 “Make cities and human settlements inclusive, safe, resilient, and sustainable”. The following description will discuss in detail features of the present multi-component type curable composition.

### [2. Multi-Component Type Curable Composition]

The present multi-component type curable composition contains, as described above, an agent A that contains a specific polyoxyalkylene-based polymer (A) having a reactive silicon group and a specific epoxy resin curing agent (B), and an agent B that contains an epoxy resin (C).

### (2-1. Polyoxyalkylene-Based Polymer (A) Having Reactive Silicon Group)

A polyoxyalkylene-based polymer (A) in accordance with one or more embodiments of the present invention has a reactive silicon group represented by general formula (1),

—Si(R)₃₋ₐ(X)ₐ (1)

where: each R independently represents a C1 to C20 hydrocarbon group or a triorganosiloxy group represented by —OSi(R′)₃ (where each R′ independently represents a C1 to C20 hydrocarbon group), and the hydrocarbon group represented as R may be subjected to substitution and has a hetero-containing group; each X independently represents a hydroxy group or a hydrolyzable group; and a represents an integer of 1 to 3.

The number of carbon atoms in the hydrocarbon group represented by R may be 1 to 10, 1 to 5, or 1 to 3. Specific examples of R encompass a methyl group, an ethyl group, a chloromethyl group, a methoxymethyl group, and an N, N-diethylaminomethyl group, and may be, a methyl group, an ethyl group, a chloromethyl group, and a methoxymethyl group, or a methyl group and a methoxymethyl group. This feature has an advantage that it is possible to easily have both storage stability and reactivity.

Examples of X encompass a hydroxy group, halogen, an alkoxy group, an acyloxy group, a ketoxymate group, an amino group, an amide group, an acid amide group, an aminooxy group, a mercapto group, and an alkenyloxy group. Among others, in view of mild hydrolyzability and easy handleability, an alkoxy group such as a methoxy group or an ethoxy group is more preferable and a methoxy group or an ethoxy group is particularly preferable.

Specific examples of the reactive silicon group of the polyoxyalkylene-based polymer (A) encompass, but are not limited to, a trimethoxysilyl group, a triethoxysilyl group, a tris(2-propenyloxy) silyl group, a triacetoxysilyl group, a dimethoxymethylsilyl group, a diethoxymethylsilyl group, a dimethoxyethylsilyl group, a (chloromethyl)dimethoxysilyl group, a (chloromethyl) diethoxysilyl group, a (methoxymethyl)dimethoxysilyl group, a (methoxymethyl) diethoxysilyl group, an (N, N-diethylaminomethyl)dimethoxysilyl group, and an (N, N-diethylaminomethyl) diethoxysilyl group. Among others, in view of obtaining a cured product that is highly active and that has favorable mechanical properties, the following groups are preferable: methyldimethoxysilyl group, a trimethoxysilyl group, a triethoxysilyl group, a (chloromethyl)dimethoxysilyl group, a (methoxymethyl)dimethoxysilyl group, a (methoxymethyl) diethoxysilyl group, and an (N, N-diethylaminomethyl)dimethoxysilyl group. Further, in view of obtaining a cured product having high rigidity, a trimethoxysilyl group and a triethoxysilyl group are more preferable, and a trimethoxysilyl group is even more preferable.

The polyoxyalkylene-based polymer (A) may have one or more reactive silicon groups on average per terminal site. The wording “have one or more reactive silicon groups on average per terminal site” indicates that the polyoxyalkylene-based polymer (A) includes a polyoxyalkylene having two or more reactive silicon groups per terminal site like a terminal site represented by general formula (4) below. In other words, the polyoxyalkylene-based polymer (A) may include only a polyoxyalkylene having two or more reactive silicon groups per terminal site. Alternatively, the polyoxyalkylene-based polymer (A) may include both a polyoxyalkylene having two or more reactive silicon groups per terminal site and a polyoxyalkylene having one reactive silicon group per terminal site. Further, as a plurality of terminal sites which a single molecule of polyoxyalkylene has, there may be both a terminal site having two or more reactive silicon groups and a terminal site having one reactive silicon group. Furthermore, the polyoxyalkylene-based polymer (A) overall has one more reactive silicon groups on average per terminal site. This polyoxyalkylene-based polymer (A) may include a polyoxyalkylene having a terminal site without a reactive silicon group.

The terminal site of the polyoxyalkylene-based polymer (A) in the present multi-component type curable composition may be represented by general formula (4):

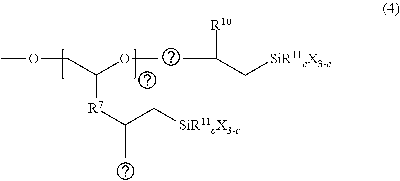

where R⁷ and R⁹ each independently represent a divalent C1-C6 bonding group, and atoms that bind to respective carbon atoms adjacent to R⁷ and R⁹ are each carbon, oxygen, or hydrogen; R⁸ and R¹⁰ each independently represent hydrogen or a C1-C10 hydrocarbon group; n represents an integer of 1 to 10; R¹¹ represents a substituted or non-substituted C1-C20 hydrocarbon group; X represents a hydroxy group or a hydrolyzable group; and c represents an integer of 1 to 3.

R⁷ and R⁹ each may be a divalent organic group that has 1 to 6 carbon atoms, may contain an oxygen atom, and/or may be a hydrocarbon group. The number of carbon atoms in the hydrocarbon group may be 1 to 4, 1 to 3, or 1 or 2. Specific examples of R⁷ encompass CH₂OCH₂, CH₂O, and CH₂, and R⁷ may be CH₂OCH₂. Specific examples of R⁹ encompass CH₂ and CH₂CH₂, and R⁹ may be CH₂.

The number of carbon atoms in the hydrocarbon group of each of R⁸ and R¹⁰ may be 1 to 5, 1 to 3, or 1 or 2. Specific examples of R⁸ and R¹⁰ encompass a hydrogen atom, a methyl group, and an ethyl group, and R⁸ and R¹⁰ each may be a hydrogen atom or a methyl group, and may be a hydrogen atom.

In a particularly preferred aspect, in the terminal site represented by general formula (4), R⁷ is CH₂OCH₂; R⁹ is CH₂; and R⁸ and R¹⁰ are each a hydrogen atom. Meanwhile, n may be an integer of 1 to 5, an integer of 1 to 3, or 1 or 2. However, n is not limited to a single value, and multiple values may be present in a mixed manner.

The number of the reactive silicon group (s) on average per terminal site of the polyoxyalkylene-based polymer (A) may be more than 1.0, not less than 1.1, not less than 1.5, or not less than 2.0. Further, the number may be not more than 5, or not more than 3.

The number of the terminal site (s) which has the one or more reactive silicon groups and which is contained in one molecule of the polyoxyalkylene-based polymer (A) may be, on average, not less than 0.5, not less than 1.0, not less than 1.1, or not less than 1.5. Further, the number may be not more than 4, or not more than 3.

The polyoxyalkylene-based polymer (A) may have a reactive silicon group at a position other than the terminal site. However, it is preferable to have a reactive silicon group only at the terminal site, in view of easily obtaining a rubber-like cured product which exhibits high elongation and which has a low elastic modulus.

The average number of the reactive silicon groups per molecule of the polyoxyalkylene-based polymer (A) may be more than 1.0, not less than 1.2, not less than 1.3, not less than 1.5, or not less than 1.7. Further, the average number may be not more than 6.0, not more than 5.5, or not more than 5.0. In a case where the average number of reactive silicon groups per molecule is not more than 1.0, it may not be possible to obtain a high-strength cured product. On the other hand, in a case where the average number of reactive silicon groups per molecule is more than 6.0, it may not be possible to obtain a high-elongation cured product.

### <Main Chain Structure>

The main chain skeleton of the polyoxyalkylene-based polymer (A) is not particularly limited. Examples of the main chain skeleton of the polyoxyalkylene-based polymer (A) include polyoxyethylene, polyoxypropylene, polyoxybutylene, polyoxytetramethylene, a polyoxyethylene-polyoxypropylene copolymer, and a polyoxypropylene-polyoxybutylene copolymer. Among others, polyoxypropylene is preferable.

The number average molecular weight of the polyoxyalkylene-based polymer (A), determined as as a polystyrene equivalent molecular weight by GPC, may be 3000 to 100000, 3000 to 50000, or 3000 to 30000. In a case where the number average molecular weight is less than 3000, the amount of reactive silicon groups introduced may be large and thus, such number average molecular weight may be disadvantageous in terms of production costs. In a case where the number average molecular weight is greater than 100000, the viscosity becomes high and thus such number average molecular weight tends to be disadvantageous in terms of workability.

The molecular weight of the polyoxyalkylene-based polymer (A) can be measured and indicated as follows: a precursor of an organic polymer prior to introduction of the reactive silicon group is directly measured for the concentration of a terminal group by a titrimetric analysis that is carried out on the basis of principles of (i) a hydroxy value measurement method defined in JIS K 1557 and (ii) an iodine value measurement method defined in JIS K 0070; and the molecular weight is indicated as a terminal group equivalent molecular weight obtained in consideration of a structure (a branching degree determined in accordance with a polymerization initiator used) of the organic polymer. The terminal group equivalent molecular weight of the polyoxyalkylene-based polymer (A) can be alternatively obtained as follows: a calibration curve of (a) the number average molecular weight obtained by general GPC measurement of a precursor of an organic polymer and (b) the terminal group equivalent molecular weight is prepared; and the number average molecular weight determined by GPC of the polyoxyalkylene-based polymer (A) is converted to the terminal group equivalent molecular weight, so that the terminal group equivalent molecular weight of the polyoxyalkylene-based polymer (A) is obtained.

A molecular weight distribution (Mw/Mn) of the polyoxyalkylene-based polymer (A) is not particularly limited. However, the molecular weight distribution (Mw/Mn) may be narrow, less than 2.0, not more than 1.6, not more than 1.5, not more than 1.4, or not more than 1.2. The molecular weight distribution of the polyoxyalkylene-based polymer (A) can be obtained from the number average molecular weight and the weight average molecular weight which are obtained by GPC measurement.

Further, the polyoxyalkylene-based polymer (A) in accordance with one or more embodiments of the present invention has a main chain structure that may be straight-chain or branched.

In one or more embodiments of the present invention, the polyoxyalkylene-based polymer (A) may contain the following (i) and/or (ii):
(i) a polyoxyalkylene-based polymer (A) that is branched and that has an alkoxy group terminal (preferably, dialkoxy group terminal); and/or
(ii) a polyoxyalkylene-based polymer (A) that is a straight chain and that has an alkoxy group terminal (preferably a dialkoxy group terminal).

In the above (i), the average number of reactive silicon groups per molecule of the polyoxyalkylene-based polymer (A) may be more than 2.0, or not less than 2.1. Further, in the above (ii), the average number of reactive silicon groups per molecule of the polyoxyalkylene-based polymer (A) may be not less than 1.7, not less than 1.8, or not less than 1.9.

Examples of the polyoxyalkylene-based polymer (A) like the above (i) encompass a polyoxyalkylene-based polymer (A-1) disclosed in Examples. Meanwhile, examples of the polyoxyalkylene-based polymer (A) like the above (ii) encompass polyoxyalkylene-based polymers (A-2), (A-4) disclosed in Examples.

In one or more embodiments of the present invention, the polyoxyalkylene-based polymer (A) may further include the following (iii):
(iii) a polyoxyalkylene-based polymer (A) that has, at only one terminal, an alkoxy group terminal (preferably, dialkoxy group terminal) and a straight chain having a reactive silicon group.

In the above (iii), the average number of reactive silicon groups per molecule of the polyoxyalkylene-based polymer (A) may be not less than 0.4, not less than 0.5, not less than 0.6, or 0.7.

Examples of the polyoxyalkylene-based polymer (A) like the above (iii) include a polyoxyalkylene-based polymer (A-3) described in Examples.

The molecular weight (Mn) of the polyoxyalkylene-based polymer (A) that is branched and that has an alkoxy group terminal is not particularly limited. However, the molecular weight (Mn) may be large, not less than 10000, not less than 15000, or not less than 17000. Further, the percentage of the weight of the polyoxyalkylene-based polymer (A) that is branched and that has an alkoxy group terminal, relative to the total of the polyoxyalkylene-based polymer (A), may be, for example, 2% to 40%, 5% to 35%, 7% to 30%, or 10% to 25%.

The polyoxyalkylene-based polymer (A) in accordance with one or more embodiments of the present invention may be a mixture of a polyoxyalkylene-based polymer (A1) having a high viscosity and a polyoxyalkylene-based polymer (A2) having a low viscosity. The mixture may be obtained by mixing one or more types of the polyoxyalkylene-based polymer (A1) and one or more types of the polyoxyalkylene-based polymer (A2).

The viscosity of the polyoxyalkylene-based polymer (A1) is not particularly limited, but may be 6.0 Pas to 50 Pas·s, 7.0 Pas·s to 48 Pas·s, or 8.0 Pas·s to 45 Pas·s. This feature has the advantage of improving adhesiveness of a resulting multi-component type curable composition and tensile elongation of a resultant cured product.

The viscosity of the polyoxyalkylene-based polymer (A2) is not particularly limited, but may be 1 Pa·s to 5 Pas·s, 1.5 Pas·s to 4 Pas·s, or 2 Pas·s to 3 Pas·s. This feature has the advantage of lowering the viscosity of a resulting multi-component type curable composition.

A weight ratio (A1):(A2) of the polyoxyalkylene-based polymer (A1) and the polyoxyalkylene-based polymer (A2) may be 98:2 to 50:50. In this range, it is possible to obtain a cured product which exhibits plasticity and high shear adhesive strength. Furthermore, in terms of achieving both high rigidity and plasticity, the weight ratio (A1):(A2) may be 95:5 to 50:50, or 90:10 to 50:50.

### <Method of Synthesizing Polyoxyalkylene-Based Polymer (A)>

Next, the following will describe a method of synthesizing the polyoxyalkylene-based polymer (A).

The reactive silicon group can be introduced into the main chain of the polyoxyalkylene-based polymer (A) by a known method. For example, the following methods can be employed.

Method I: React (i) an organic polymer having a functional group such as a hydroxy group with (ii) a compound having (a) an active group that is reactive with the functional group and (b) an unsaturated group, so as to obtain an organic polymer having an unsaturated group. Next, react (i) a resulting organic polymer having the unsaturated group with (ii) a hydrosilane compound having a reactive silicon group by hydrosilylation.

Examples of the compound used in Method I which has (a) an active group that is reactive and (b) an unsaturated group encompass: unsaturated-group-containing epoxy compounds such as allyl glycidyl ether; and a compounds each having a carbon-carbon double bond such as allyl chloride, methallyl chloride, vinyl bromide, allyl bromide, methallyl bromide, vinyl iodide, allyl iodide, and methallyl iodide.

Further, examples of a compound having a carbon-carbon triple bond encompass halogenated hydrocarbon compounds each having a carbon-carbon triple bond, such as propargyl chloride, 1-chloro-2-butyne, 4-chloro-1-butyne, 1-chloro-2-octyne, 1-chloro-2-pentyne, 1,4-dichloro-2-butyne, 5-chloro-1-pentyne, 6-chloro-1-hexyne, propargyl bromide, 1-bromo-2-butyne, 4-bromo-1-butyne, 1-bromo-2-octyne, 1-bromo-2-pentyne, 1,4-dibromo-2-butyne, 5-bromo-1-pentyne, 6-bromo-1-hexyne, propargyl iodide, 1-iodo-2-butyne, 4-iodo-1-butyne, 1-iodo-2-octyne, 1-iodo-2-pentyne, 1,4-diiodo-2-butyne, 5-iodo-1-pentyne, and 6-iodo-1-hexyne. Among others, propargyl chloride, propargyl bromide, and propargyl iodide are more preferable.

It is possible to use, at the same as a halogenated hydrocarbon compound having a carbon-carbon triple bond, a hydrocarbon compound having an unsaturated bond other than a halogenated hydrocarbon having a carbon-carbon triple bond. Examples of such a hydrocarbon compound having an unsaturated bond encompass: vinyl chloride, allyl chloride, methallyl chloride, vinyl bromide, allyl bromide, methallyl bromide, vinyl iodide, allyl iodide and methallyl iodide.

Examples of the hydrosilane compound that can be used in Method I encompass halogenated silanes, alkoxysilanes, acyloxysilanes, and ketoxymatesilanes. The hydrosilane compound is not limited to these.

Examples of the halogenated silanes encompass trichlorosilane, methyldichlorosilane, dimethylchlorosilane, and phenyldichlorosilane.

Examples of the alkoxysilanes encompass trimethoxysilane, triethoxysilane, triisopropoxysilane, dimethoxymethylsilane, diethoxymethylsilane, diisopropoxymethylsilane, (methoxymethyl)dimethoxysilane, phenyldimethoxysilane, and 1-[2-(trimethoxysilyl)ethyl]-1,1,3,3-tetramethyldisiloxane.

Examples of the acyloxysilanes encompass methyldiacetoxysilane and phenyldiacetoxysilane.

Examples of the ketoxymatesilanes encompass bis(dimethylketoxymate)methylsilane and bis(cyclohexylketoxymate)methylsilane.

Among others, halogenated silanes and alkoxysilanes are particularly preferable. Alkoxysilanes are most preferable because alkoxysilanes have mild hydrolyzability and are easy to handle.

Out of those alkoxysilanes, for example, dimethoxymethylsilane is preferable because: dimethoxymethylsilane is easily obtainable; it is possible to easily obtain a resin composition that is for a foamed body and that is excellent in curability and storage stability; and a foamed body excellent in tensile strength can be easily produced with use of the resin composition for a foamed body. Also, trimethoxysilane and triethoxysilane are preferable because it is possible to obtain a resin composition that is for a foamed body and that is excellent in curability.

Method II: A method in which a radical addition reaction in the presence of a radical initiator and/or a radical generation source is used to introduce a compound having a mercapto group and a reactive silicon group into an unsaturated group site of an organic polymer having an unsaturated group, the organic polymer being obtained as in Method I.

Examples of the compound having a mercapto group and a reactive silicon group for use in Method II encompass 3-mercapto-n-propyltrimethoxysilane, 3-mercapto-n-propylmethyldimethoxysilane, 3-mercapto-n-propyltriethoxysilane, 3-mercapto-n-propylmethyldiethoxysilane, mercaptomethyltrimethoxysilane, and mercaptomethyltriethoxysilane. The compound having a mercapto group and a reactive silicon group is not limited to these.

Method III: A method in which an organic polymer having in its molecule a functional group such as a hydroxy group, an epoxy group, or an isocyanate group is reacted with a compound having a reactive silicon group and a functional group that is reactive with the functional group of the organic polymer.

A method of reacting an organic polymer having a hydroxy group with a compound having an isocyanate group and a reactive silicon group, which can be employed in Method III, is not particularly limited. The method can be, for example, a method disclosed in Japanese Patent Application Publication Tokukaihei No. 3-47825.

Examples of the compound having an isocyanate group and a reactive silicon group for use in Method III encompass 3-isocyanato-n-propyltrimethoxysilane, 3-isocyanato-n-propylmethyldimethoxysilane, 3-isocyanato-n-propyltriethoxysilane, 3-isocyanate-n-propylmethyldiethoxysilane, isocyanatemethyltrimethoxysilane, isocyanatomethyltriethoxysilane, isocyanatomethyldimethoxymethylsilane, and isocyanatomethyldiethoxymethylsilane. The compound having an isocyanate group and a reactive silicon group is not limited to these.

A disproportional reaction may proceed, in a case where a silane compound in which three hydrolyzable groups are bonded to one silicon atom, such as trimethoxysilane, is used. As such a disproportional reaction proceeds, an unstable compound such as dimethoxysilane may be produced. This makes handling difficult. However, in a case where 3-mercapto-n-propyltrimethoxysilane or 3-isocyanato-n-propyltrimethoxysilane is used, this disproportional reaction will not proceed. As such, in a case where a group in which three hydrolyzable groups such as trimethoxysilyl groups are bonded to one silicon atom is used as the silicon-containing group, Method II or Method III may be used.

A disproportional reaction will not proceed with use of a silane compound represented by the following formula (2a):

H—(SiR^{2a}₂O)ₘSiR^{2a}₂—R^{3a}—SiX₃ (2a)

where X in formula (2a) is the same as X in formula (1a), The number (2m+2) of R₂ₐs each independently represent the same as R^{1a} of formula (1a). R^{3a} represents a substituted or non-substituted divalent hydrocarbon group having 1 to 20 carbon atoms. m represents an integer of not less than 0 and not more than 19.

As such, in a case where Method I involves introducing a group in which three hydrolyzable groups are bonded to a single silicon atom, the silane compound represented by formula (2a) may be used. In terms of availability and cost, the 2m+2 number of Res each independently may be a hydrocarbon group having 1 to 20 carbon atoms, a hydrocarbon group having 1 to 8 carbon atoms, or a hydrocarbon group having 1 to 4 carbon atoms. R^{3a} may be a bivalent hydrocarbon group having 1 to 12 carbon atoms, a bivalent hydrocarbon group having 2 to 8 carbon atoms, or a bivalent hydrocarbon group having 2 carbon atoms. “m” may be 1.

Examples of the silane compound represented by formula (2a) encompass 1-[2-(trimethoxysilyl)ethyl]-1,1,3,3-tetramethyldisiloxane, 1-[2-(trimethoxysilyl) propyl]-1,1,3,3-tetramethyldisiloxane, and 1-[2-(trimethoxysilyl) hexyl]-1,1,3,3-tetramethyldisiloxane.

In the Method I or Method III, it is preferable to use a method in which an organic polymer having a hydroxy group as a terminal group is reacted with a compound having an isocyanate group and a reactive silicon group, because with such a method, a high conversion rate can be achieved in a comparatively short reaction time. Further, Method I is particularly preferable. This is because (i) an organic polymer having a reactive silicon group obtained by Method I has lower viscosity than an organic polymer having a reactive silicon group as obtained by Method III, (ii) it is possible to obtain a resin composition for a foamed body having good workability, and (iii) an organic polymer having a reactive silicon group as obtained by Method II has a strong odor due to mercaptosilane.

Examples of the polyoxyalkylene-based polymer having a reactive silicon group encompass respective polymers proposed in e.g. Japanese Examined Patent Application Publication, Tokukoushou, No. 45-36319, Japanese Examined Patent Application Publication, Tokukoushou, No. 46-12154, Japanese Patent Application Publication, Tokukaisho, No. 50-156599, Japanese Patent Application Publication, Tokukaisho, No. 54-6096, Japanese Patent Application Publication, Tokukaisho, No. 55-13767, Japanese Patent Application Publication, Tokukaisho, No. 55-13468, Japanese Patent Application Publication, Tokukaisho, No. 57-164123, Japanese Examined Patent Application Publication, Tokukouhei, No. 3-2450, U.S. Pat. Nos. 3,632,557, 4,345,053, 4,366,307, and 4,960,844. Further, preferable examples of the polyoxyalkylene-based polymer having a reactive silicon group encompass polyoxyalkylene-based polymers each of which has (i) a reactive silicon group, (ii) a number average molecular weight of not less than 6,000, and thus a high molecular weight, and (iii) a molecular weight distribution (Mw/Mn) of not more than 1.6 or more not than 1.3, and thus a narrow molecular weight distribution, and which are proposed in Japanese Patent Application Publication, Tokukaisho, No. 61-197631, Japanese Patent Application Publication, Tokukaisho, No. 61-215622, Japanese Patent Application Publication, Tokukaisho, No. 61-215623, Japanese Patent Application Publication, Tokukaisho, No. 61-218632, Japanese Patent Application Publication, Tokukaihei, No. 3-72527, Japanese Patent Application Publication, Tokukaihei, No. 3-47825, and Japanese Patent Application Publication, Tokukaihei, No. 8-231707. One type of such a polyoxyalkylene-based polymer having a reactive silicon group may be used alone, or two or more types thereof may be used in combination.

The following description will discuss a method for synthesizing a polyoxyalkylene-based polymer in which more than 1.0 reactive silicon groups are introduced per terminal site of the polyoxyalkylene-based polymer on average.

A polyoxyalkylene-based polymer (A) having an average of 1.0 or more reactive silicon groups per terminal site may be obtained as follows: two or more carbon-carbon unsaturated bonds are introduced into one terminal site of a hydroxy group-terminated polymer obtained by polymerization; and then a reactive silicon group-containing compound capable of reacting with the carbon-carbon unsaturated bonds are reacted.

### (Polymerization)

For the polyoxyalkylene-based polymer (A), it is preferable to use a method in which an epoxy compound is polymerized with an initiator having a hydroxy group, with use of a double metal cyanide complex catalyst such as a zinc hexacyanocobaltate glyme complex.

Examples of the initiator having a hydroxy group encompass an initiator having one or more hydroxy groups such as ethylene glycol, propylene glycol, glycerin, pentaerythritol, a low-molecular-weight polyoxypropylene glycol, polyoxypropylene triol, allyl alcohol, a polypropylene monoallyl ether, and a polypropylene monoalkyl ether.

Examples of the epoxy compound encompass: alkylene oxides such as ethylene oxide and propylene oxide; and glycidyl ethers such as a methylglycidyl ether and an allyl glycidyl ether. Among these, propylene oxide is preferable.

### (Introduction of Carbon-Carbon Unsaturated Bond)

It is preferable to use, as a method of introducing two or more carbon-carbon unsaturated bonds into one terminal, a method in which: an alkali metal salt is caused to act on a hydroxy group-terminated polymer; then, first an epoxy compound having a carbon-carbon unsaturated bond is reacted; and subsequently, a halogenated hydrocarbon compound having a carbon-carbon unsaturated bond is reacted. With use of this method, it is possible to efficiently and stably introduce a reactive group while controlling the molecular weight and molecular weight distribution of the main chain of a polymer by polymerization conditions.

The alkali metal salt used in one or more embodiments of the present invention may be sodium hydroxide, sodium methoxide, sodium ethoxide, potassium hydroxide, potassium methoxide, or potassium ethoxide, or, sodium methoxide or potassium methoxide. In terms of availability, sodium methoxide is particularly preferable.

The alkali metal salt may be caused to act at a temperature of not lower than 50° C. and not higher than 150° C., or not lower than 110° C. and not higher than 140° C. Further, the alkali metal salt may be caused to react for a period of not less than 10 minutes but not more than 5 hours, or not less than 30 minutes but not more than 3 hours.

As an epoxy compound having a carbon-carbon unsaturated bond used in one or more embodiments of the present invention, it is possible to suitably use a compound represented by general formula (5):

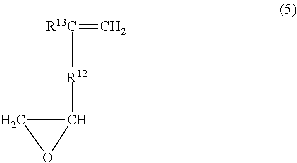

where R¹² and R¹³ are the same as the above-described R⁷ and R⁸, respectively. Specifically, the compound may be allyl glycidyl ether, methallyl glycidyl ether, glycidyl acrylate, glycidyl methacrylate, butadiene monoxide, or 1,4-cyclopentadiene monoepoxide in terms of reaction activity, or allyl glycidyl ether.

With regard to the epoxy compound having a carbon-carbon unsaturated bond used in one or more embodiments of the present invention, an amount of the epoxy compound added can be an arbitrary amount set in view of an amount of the carbon-carbon unsaturated bond introduced to the polymer and reactivity. In particular, a molar ratio of the epoxy compound to the hydroxy group of the hydroxy group-terminated polymer may be not less than 0.2, or not less than 0.5. On the other hand, the molar ratio may be not more than 5.0, or not more than 2.0.

In one or more embodiments of the present invention, with regard to a reaction temperature in a case where an epoxy compound having a carbon-carbon unsaturated bond is subjected to a cycloaddition reaction with respect to a polymer containing a hydroxy group, the reaction temperature may be not lower than 60° C. and not higher than 150° ° C., or not lower than 110° C. and not higher than 140° C.

Examples of the halogenated hydrocarbon compound having a carbon-carbon unsaturated bond used in one or more embodiments of the present invention may encompass vinyl chloride, allyl chloride, methallyl chloride, vinyl bromide, allyl bromide, methallyl bromide, vinyl iodide, allyl iodide, and methallyl iodide, and in view of easy handleability, more preferably, allyl chloride and methallyl chloride.

The amount in which the halogenated hydrocarbon compound having a carbon-carbon unsaturated bond is added is not particularly limited, but a molar ratio of the halogenated hydrocarbon compound with respect to the hydroxy group contained in the hydroxy group-terminated polymer may be not less than 0.7, or not less than 1.0. On the other hand, the molar ratio may be not more than 5.0, or not more than 2.0.

The halogenated hydrocarbon compound having a carbon-carbon unsaturated bond may be reacted at a temperature of not lower than 50° C. but not higher than 150° ° C., or not lower than 110° C. but not higher than 140° C. The halogenated hydrocarbon compound may be reacted for not less than 10 minutes but not more than 5 hours, or not less than 30 minutes but not more than 3 hours.

### (Introduction of Reactive Silicon Group)

As a method of introducing a reactive silicon group, the above-described three kinds of methods can be used. The method is not particularly limited, and another known method can be used.

### (2-2. Epoxy Resin Curing Agent (B))

The epoxy resin curing agent (B) in the present multi-component type curable composition is an epoxy resin curing agent represented by the following general formula (2):

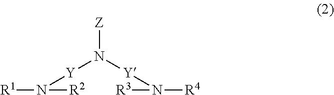

where: Z represents hydrogen, an N-containing alkyl group represented by general formula (3) below, or a C2 or higher straight-chain or branched alkyl group; R¹ to R⁴ independently represent a straight-chain or branched alkyl group; and Y and Y′ each independently represent a straight-chain or branched alkylene group,

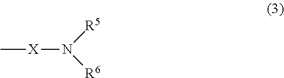

where: X represents a straight-chain or branched alkylene group; R⁵ and R⁶ each independently represent a straight-chain or branched alkyl group; and Y and Y′ each independently represent a straight-chain or branched alkylene group. This feature can improve a residual tackiness after one day of the cured product.

In formula (2) above, R¹ to R⁴ each independently represent a straight-chain or branched alkyl group. The number of carbon atoms in each of the alkyl groups of R¹ to R⁴ may be 1 to 10, 1 to 5, or 1 to 3. The alkyl groups of R¹ to R⁶ can be each either a straight-chain or branched alkyl group, and each may be a straight alkyl group.

In formula (2), Y and Y′ each independently represent a straight-chain or branched alkylene group. The number of carbon atoms in the alkylene groups Y and Y′ may be 1 to 15, 1 to 10, or 1 to 5. The alkylene groups Y and Y′ can be each a straight-chain or branched alkylene group, but each may be a straight alkylene group.

In formula (2), Z represents hydrogen, an N-containing alkyl group represented by general formula (3), or a straight-chain or branched alkyl group having not less than 2 carbon atoms. In a case where Z is an N-containing alkyl group represented by general formula (3), R⁵ and R⁶ are each independently a straight-chain or branched alkyl group. The number of carbon atoms in each of the alkyl groups of R⁵ and R⁶ may be 1 to 10, 1 to 5, or 1 to 3. The alkyl groups of R⁵ to R⁶ can be each either a straight-chain or branched alkyl group, and each may be a straight alkyl group. In a case where Z is a straight-chain or branched alkyl group having 2 or more carbon atoms, the number of carbon atoms in the alkyl group may be, for example, 2 to 10, 1 to 5, or 1 to 3. The alkyl group may be a straight-chain or branched alkyl group, but may be a straight alkyl group.

In formula (3), each X independently represents a straight-chain or branched alkylene group. The number of carbon atoms in the alkylene group of X may be 1 to 15, 1 to 10, or 1 to 5. The alkylene group of X may be a straight-chain or branched alkylene group, but may be a straight alkylene group.

Alkyl groups and alkylene groups of the epoxy resin curing agent represented by general formula (2) may be each independently substituted by an optional substituent. Examples of such a substituent encompass ethyl, propyl, ethylene, and propylene.

In one or more embodiments of the present invention, in the epoxy resin curing agent represented by general formula (2), it is preferable that: Z be hydrogen or an N-containing alkyl group represented by general formula (3); X, Y, and Y′ each represent a straight-chain alkylene group having 3 carbon atoms; and R¹ to R⁶ may be a methyl group.

Examples of the epoxy resin curing agent represented by general formula (2) encompass tris(3-dimethylamino) propyl)amine (“JEFFADD (registered trademark) MW-760” manufactured by HUNTSMAN Japan KK) and tetramethyliminobispropylamine (“JEFFCAT Z-130” manufactured by HUNTSMAN Japan KK).

A content of the epoxy resin curing agent (B) may be 0.1 parts by weight to 20 parts by weight, 0.5 parts by weight to 19 parts by weight, 1.0 part by weight to 18 parts by weight, 1.5 parts by weight to 17 parts by weight, or 2.0 parts by weight to 16 parts by weight, with respect to a combined total of 100 parts by weight of the polyoxyalkylene-based polymer (A) and the epoxy resin (C).

In one or more embodiments of the present invention, the present multi-component type curable composition may contain an epoxy curing agent other than the epoxy resin curing agent (B). By including, in addition to the epoxy resin curing agent (B), an epoxy resin curing agent other than the epoxy resin curing agent (B), fast curability of the epoxy resin is achieved.

Examples of the epoxy resin curing agent other than the epoxy resin curing agent (B) encompass, but are not particularly limited to, the following: N, N-diethyl-1,3-propanediamine (DEAPA) (“Reagent N, N-diethyl-1,3-propanediamine” manufactured by FUJIFILM Wako Pure Chemical Corporation); a mixture of tris-2,4,6-(dimethylaminomethyl) phenol and bis(dimethylaminomethyl) phenol (“ANCAMINE (registered trademark) K54” manufactured by Evonik Japan Co., Ltd.); pentamethyl-dipropylenetriamine (“JEFFADD (registered trademark) MW-740″manufactured by HUNTSMAN Japan KK); 1-(bis(3-(dimethylamino) propyl)amino)-2-propanol (“JEFFADD (registered trademark) MW-750” manufactured by HUNTSMAN Japan KK); 1,1,4,7,10,10-hexamethyltriethylenetetramine (HMTETA) (“C3070” manufactured by Koei Chemical Co., Ltd.); a mixture of dimethylamino (methyl) phenol and phenol (“ANCAMINE (registered trademark) 1110” manufactured by Evonik Japan Co., Ltd.); N, N, N, N-tetramethyl-1,6-hexanediaminodiamine (“TOYOCAT-MR” manufactured by Tosoh Corporation); and hexahydro-1,3,5-tris(3-dimethylaminopropyl)-1,3,5-triazine (“TOYOCAT-TRC” manufactured by Tosoh Corporation). In terms of low odor and low cost, it is preferable to that the epoxy resin curing agent other than the epoxy resin curing agent (B) be N, N-diethyl-1,3-propanediamine (DEAPA).

A content of the epoxy resin curing agent other than the epoxy resin curing agent (B) may be, for example, 0 parts by weight to 7.0 parts by weight, 0 parts by weight to 5.0 parts by weight, 0 parts by weight to 4.0 parts by weight, or 0 parts by weight to 3.0 parts by weight, with respect to a combined total of 100 parts by weight of the polyoxyalkylene-based polymer (A) and the epoxy resin (C).

### (2-3. Epoxy Resin (C))

The epoxy resin (C) in the present multi-component type curable composition may be an epoxy resin having two or more epoxy groups per molecule. This feature has the advantage of improving the tear strength of the cured product.

As the epoxy resin (C), an epoxy resin that is commonly used can be employed. Examples of the epoxy resin (C) encompass, but are not limited to, epichlorohydrin-bisphenol A epoxy resin, epichlorohydrin-bisphenol F epoxy resin, a flame retardant epoxy such resin as glycidyl ether of tetrabromobisphenol A, novolac-type epoxy resin, hydrogenated bisphenol A epoxy resin, a glycidyl ether-type epoxy resin of bisphenol A propylene oxide adduct, p-oxybenzoic glycidyl ether ester type epoxy resin, m-aminophenol-based epoxy resin, diaminodiphenylmethane-based epoxy resin, urethane-modified epoxy resin; various types of alicyclic epoxy resin; N, N-diglycidylaniline, N, N-diglycidyl-o-toluidine, triglycidyl isocyanurate, polyalkylene glycol diglycidyl ether, glycidyl ether of a polyvalent alcohol such as glycerin, hydantoin-type epoxy resin and an epoxidized unsaturated polymer such as petroleum resin. The epoxy resin having at least two epoxy groups per molecule is preferable because, for example, (i) such an epoxy resin has high reactivity when cured and (ii) a cured product of such an epoxy resin is likely to form a three-dimensional network. More preferable examples of the epoxy resin (C) encompass bisphenol A-type epoxy resins and novolac-type epoxy resins.

With regard to a content of the epoxy resin (C), a weight ratio (A):(C) of the polyoxyalkylene-based polymer (A) and the epoxy resin (C) may be 90:10 to 50:50. When the ratio of (A) is larger than 90%, a resultant cured product has lower strength. On the other hand, when the ratio of (A) is smaller than 50%, a resultant cured product has lower plasticity and becomes too hard. Furthermore, the weight ratio (A):(C) may be 80:20 to 60:40 in view of a balance between plasticity and strength.

### (2-4. Aminosilane (D))

The multi-component type curable composition may further contain aminosilane (D). The present multi-component type curable composition containing aminosilane (D) is likely to achieve both improvement in tear strength and reduction in cost of a cured product.

Examples of the aminosilane (D) in the present multi-component type curable composition encompass γ-aminopropyltriethoxysilane, N-β-(aminoethyl)-γ-aminopropyltrimethoxysilane, and N-β-(aminoethyl)-γ-aminopropylmethyldimethoxysilane. One type of these substances may be used alone, or two or more types thereof may be used in combination. Examples of a commercially available product that can be used encompass: Silquest A-1120 (manufactured by Momentive Performance Materials Japan LLC), Silquest A-1110 (manufactured by Momentive Performance Materials Japan LLC), KBM-602 (manufactured by Shin-Etsu Chemical Co., Ltd.), KBM-603 (manufactured by Shin-Etsu Chemical Co., Ltd.), and KBM-903 (manufactured by Shin-Etsu Chemical Industry Co., Ltd.).

A content of the aminosilane (D) may be 0.1 parts by weight to 3.0 parts by weight, 0.2 parts by weight to 2.5 parts by weight, 0.4 parts by weight to 2.0 parts by weight, or 0.5 parts by weight to 1.5 parts by weight, with respect to a combined total of 100 parts by weight of the polyoxyalkylene-based polymer (A) and the epoxy resin (C). In a case where the content of the aminosilane (D) is within the above ranges, there is an advantage that both improvement in tear strength and reduction in cost of the cured product are likely to be achieved.

### (2-5. Mercaptan Compound (E))

The present multi-component type curable composition may further contain a mercaptan compound (E). The present multi-component type curable composition containing a mercaptan compound easily achieves both improvement in tear strength and reduction in cost of a cured product.

Examples of the mercaptan compound (E) in the present multi-component type curable composition encompass: n-dodecylmercaptan, tert-dodecylmercaptan, lauryl mercaptan, trimethylolpropane tris(3-mercaptopropionate), pentaerythritoltetrakis(3-mercaptopropionate), 3-mercaptopropyltrimethoxysilane, 3-mercaptopropylmethyldimethoxysilane, 3-mercaptopropylchloromethyldimethoxysilane, 3-mercaptopropylmethoxymethyldimethoxysilane, (mercaptomethyl)dimethoxymethylsilane, and (mercaptomethyl)trimethoxysilane. One type of these compounds may be used alone, or two or more types thereof may be used in combination. Examples of a commercially available product that can be used encompass: Z6062 (manufactured by Dow Chemical Japan Ltd.), THIOKALCOL 20 (manufactured by Kao Corporation), KBM-802 (manufactured by Shin-Etsu Chemical Co., Ltd.), and KBM-803 (manufactured by Shin-Etsu Chemical Co., Ltd.).

A content of the mercaptan compound (E) may be 0.1 parts by weight to 3.0 parts by weight, 0.2 parts by weight to 2.5 parts by weight, 0.4 parts by weight to 2.0 parts by weight, or 0.5 parts by weight to 1.5 parts by weight, with respect to a combined total of 100 parts by weight of the polyoxyalkylene-based polymer (A) and the epoxy resin (C). In a case where the content of the mercaptan compound (E) is within the above ranges, there is an advantage that both improvement in tear strength and reduction in cost of the cured product are likely to be achieved.

### (2-6. Hydroxy Group-Containing Polyoxyalkylene-Based Polymer (F))

The present multi-component type curable composition may further contain a hydroxy group-containing polyoxyalkylene-based polymer (F). In the present multi-component type curable composition, the hydroxy group-containing polyoxyalkylene-based polymer (F) functions as a plasticizer. By containing the hydroxy group-containing polyoxyalkylene-based polymer (F) in the present multi-component type curable composition, it is possible to achieve reduction in viscosity and reduction in cost of the composition and to adjust characteristics such as curability and elastic modulus of a cured product that is made from the composition.

The hydroxy group-containing polyoxyalkylene-based polymer (F) may be contained in the agent A, may be contained in the agent B, or may be contained in both the agent A and the agent B.

The hydroxy group-containing polyoxyalkylene-based polymer (F) is used as a plasticizer for the polyoxyalkylene-based polymer (A), and therefore preferably does not contain a group, such as a reactive silicon group contained in the oxyalkylene-based polymer (A), that can be crosslinked at room temperature.

The hydroxy group-containing polyoxyalkylene-based polymer (F) has a main chain having monomer units, not less than 60% and preferably not less than 80% of which are repeating units each represented by the following general formula:

—R^{f}—O—

where R^{f} represents a divalent hydrocarbon group, and most preferably, a most part of the divalent hydrocarbon group is constituted by a C3 or C4 alkylene group. Specific examples of the R^{f} encompass

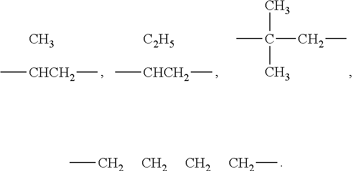

The hydroxy group-containing polyoxyalkylene-based polymer (F) has a molecular chain that may be constituted by a single type of repeating unit or that may be constituted by two or more types of repeating units. R^{f} may be a group represented by

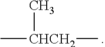

Specific examples of the hydroxy group-containing polyoxyalkylene-based polymer (F) encompass, but are not limited to, polyoxyethylene, polyoxypropylene, polyoxybutylene, polyoxytetramethylene, a polyoxyethylene-polyoxypropylene copolymer, and a polyoxypropylene-polyoxybutylene copolymer. Among others, polyoxypropylene is preferable in terms of suppressing bleed that occurs as time elapses.

Since the hydroxy group-containing polyoxyalkylene-based polymer (F) acts as a plasticizer for the polyoxyalkylene-based polymer (A) having a reactive silicon group, the number average molecular weight of the hydroxy group-containing polyoxyalkylene-based polymer (F) is required to be smaller than that of the polyoxyalkylene-based polymer (A). The number average molecular weight of the hydroxy group-containing polyoxyalkylene-based polymer (F) may be not less than 300, not less than 800, or not less than 1000. The upper limit of the number average molecular weight may be not more than 15000, not more than 10000, not more than 8000, or not more than 5000. The hydroxy group-containing polyoxyalkylene-based polymer (F) having a number average molecular weight of not less than 300 yields the effect of being unlikely to evaporate. The hydroxy group-containing polyoxyalkylene-based polymer (F) having a number average molecular weight of not more than 15000 yields an effect that a multi-component type curable composition is likely to have a lower viscosity. The number average molecular weight of the hydroxy group-containing polyoxyalkylene-based polymer (F) is a molecular weight equivalent to the number average molecular weight that is obtained by terminal group analysis.

In a case where a molecular weight distribution of the hydroxy group-containing polyoxyalkylene-based polymer (F) is smaller, the viscosity is lower. Therefore, a smaller molecular weight distribution is preferable. The molecular weight distribution of the hydroxy group-containing polyoxyalkylene-based polymer (F) may be, for example, not more than 1.6 (Mw/Mn) or not more than 1.5 (Mw/Mn). The molecular weight distribution (Mw/Mn) of the hydroxy group-containing polyoxyalkylene-based polymer (F) is measured by GPC (polystyrene equivalent).

A content of the hydroxy group-containing polyoxyalkylene-based polymer (F) may be not less than 5 parts by weight, not less than 10 parts by weight, or not less than 20 parts by weight, with respect to a combined total of 100 parts by weight of the polyoxyalkylene-based polymer (A) and the epoxy resin (C). The upper limit of the content may be not more than 150 parts by weight, not more than 100 parts by weight, or not more than 50 parts by weight. In a case where the content of the hydroxy group-containing polyoxyalkylene-based polymer (F) is not less than 5 parts by weight, it is possible to sufficiently exert an effect of the hydroxy group-containing polyoxyalkylene-based polymer (F) as a plasticizer. On the other hand, in a case where the content of the hydroxy group-containing polyoxyalkylene-based polymer (F) is not more than 150 parts by weight, a moderate mechanical strength of the cured product can be achieved. Note that the hydroxy group-containing polyoxyalkylene-based polymer (F) can also be mixed during polymer production.

The hydroxy group-containing polyoxyalkylene-based polymer (F) can be produced by a polymerization method using an ordinary caustic alkali, or can be produced by a polymerization method using, as a catalyst, a double metal cyanide complex such as zinc hexacyanocobaltate.

### (2-7. Inorganic Filler)

The present multi-component type curable composition may further contain an inorganic filler. The inorganic filler is an inexpensive material and therefore makes it possible to reduce costs.

Examples of the inorganic filler encompass, but are not particularly limited to, calcium carbonate, magnesium carbonate, barium carbonate, barium sulfate, diatomite, calcined clay, clay, talc, barite, anhydride, titanium oxide, bentonite, organobentonite, ferric oxide, fine aluminum powder, flint powder, zinc oxide, active zinc oxide, mica, hydrozincite, white lead, lithopone, zinc sulfide, shirasu balloons, and glass microballoons. Among others, in terms of lower cost, calcium carbonate preferable. Moreover, in terms of physical properties of tension, an organic filler having a smaller particle size is preferable. Meanwhile, in terms of suppression of physical property deterioration after a water resistance test, heavy calcium carbonate without surface treatment is preferable. Further, in terms of weather resistance, titanium oxide is preferable, and rutile-type titanium oxide is more preferable. One type of these inorganic fillers may be used alone, or two or more types thereof may be used in combination.

A content of the inorganic filler may be 20 parts by weight to 300 parts by weight, 20 parts by weight to 250 parts by weight, 25 parts by weight to 200 parts by weight, 30 parts by weight to 180 parts by weight, or 28 parts by weight to 200 parts by weight, with respect to a combined total of 100 parts by weight of the polyoxyalkylene-based polymer (A) and the epoxy resin (C). In a case where the content of the inorganic filler is within the above ranges, there is an advantage that both reduction in viscosity and reduction in cost of the multi-component type curable composition are likely to be achieved.

The inorganic filler may be contained in the agent A, may be contained in the agent B, or may be contained in both the agent A and the agent B. The inorganic filler may be contained in a solution B (agent B) in terms of adsorbed water.

### (2-8. Curing Catalyst)

The present multi-component type curable composition may further contain a curing catalyst. The curing catalyst is not particularly limited, but can be any curing catalyst as long as the curing catalyst can be used as a condensation catalyst.

Examples of the curing catalyst encompass: (a) tetravalent tin compounds including: for example, dialkyltin dicarboxylates such as dibutyltin dilaurate, dibutyltin diacetate, dibutyltin diethylhexanoate, dibutyltin dioctate, dibutyltin dimethylmalate, dibutyltin diethylmalate, dibutyltin dibutylmalate, dibutyltin diisocotylmalate, dibutyltin ditridecylmalate, dibutyltin dibenzylmalate, dibutyltin maleate, dioctyltin diacetate, dioctyltin distearate, dioctyltin dilaurate, dioctyltin diethylmalate, and dioctyltin diisoctylmalate; for example, dialkyltin alkoxides such as dibutyltin dimethoxide and dibutyltin diphenoxide; for example, intramolecular coordinated derivatives of dialkyltin such as dibutyltin diacetylacetonate and dibutyltin diethylacetoacetate; a reaction product of, for example, a dialkyltin oxide such as dibutyltin oxide or dioctyltin oxide and, for example, an ester compound such as dioctyl phthalate, diisodecyl phthalate, or methyl maleate; a tin compound obtained by reacting dialkyltin oxide, a carboxylic acid, and an alcohol compound; for example, a reaction product of dialkyltin oxide and a silicate compound, such as dibutyltin bistriethoxysilicate or dioctyltin bistriethoxysilicate; and oxyderivatives (stannoxane compounds) of these dialkyltin compounds; (b) divalent tin compounds including, for example, tin octylate, tin naphthenate, tin stearate, and tin ferzatic acid, or reaction products or mixtures of any of the divalent tin compounds and an amine-based compound, such as laurylamine, which will be described later; (c) monoalkyltins including, for example, monobutyl as monobutyltin trisoctoate and monobutyltin triisopropxide, and monooctyltin compounds; (d) titanate esters including, for example, tetrabutyltitanate, tetrapropyltitanate, tetra(2-ethtylhexyl) titanate, and isopropoxytitanium bis(ethylacetoacetate); (e) organic aluminum compounds such as aluminum trisacetylacetonate, aluminum trisethylacetoacetate, and di-isopropoxyaluminum ethylacetoacetate; (f) metal salts of carboxylic acids (2-ethylhexanoic acid, neodecanoic acid, versatic acid, oleic acid, as bismuth carboxylate, iron and naphthenic acid), such carboxylate, titanium carboxylate, lead carboxylate, vanadium carboxylate, zirconium carboxylate, calcium carboxylate, potassium carboxylate, barium carboxylate, manganese carboxylate, cerium carboxylate, nickel carboxylate, cobalt carboxylate, zinc carboxylate, and aluminum carboxylate, or reaction products and mixtures of any of the metal salts of carboxylic acids and an amine-based compound such as laurylamine, which will be described later; (g) chelating compounds such as zirconium tetraacetylacetonate, zirconium tributoxyacetylacetonate, dibutoxyzirconium diacetylacetonate, zirconium acetylacetonate bis(ethylacetoacetate), and titanium tetraacetylacetonate; (h) aliphatic primary amines such as methylamine, ethylamine, propylamine, isopropylamine, butylamine, amylamine, hexylamine, octylamine, 2-ethylhexylamine, nonylamine, decylamine, laurylamine, pentadecylamine, cetylamine, stearylamine, and cyclohexylamine; (i) aliphatic secondary amines such as dimethylamine, diethylamine, dipropylamine, diisopropylamine, dibutylamine, diamylamine, dioctylamine, di(2-ethylhexyl)amine, didecylamine, dilaurylamine, dicethylamine, distearylamine, methylstearylamine, ethylstearylamine, and butylstearylamine; (j) aliphatic tertiary amines such as triamilamine, trihexylamine, and trioctylamine; (k) aliphatic unsaturated amines such as triallylamine and oleylamine; (1) aromatic amines such as laurylaniline, stearylaniline, and triphenylamine; and (m) other amines including: amine-based compounds such as monoethanolamine, diethanolamine, triethanolamine, diethylenetriamine, triethylenetetramine, oleylamine, cyclohexylamine, benzylamine, diethylaminopropylamine, xylylenediamine, ethylenediamine, hexamethylenediamine, triethylenediamine, guanidine, diphenylguanidine, 2,4,6-tris(dimethylaminomethyl) phenol, morpholine, N-methylmorpholine, 2-ethyl-4-methylimidazole, and 1,8-diazabicyclo(5,4,0) undecene-7 (DBU) or salts of these amine-based compounds with, for example, carboxylic acid; reaction products and mixtures of any of the amine-based compounds and an organotin compound, such as a reaction product or a mixture of laurylamine and tin octylate; low molecular weight polyamide resins obtained from excess polyamine and a polybasic acid; and reaction products of excess polyamine with an epoxy compound; and γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, N-(β-aminoethyl)aminopropyltrimethoxysilane, N-(β-aminoethyl)aminopropylmethyldimethoxysilane, N-(β-aminoethyl)aminopropyltriethoxysilane, N-(β-aminoethyl)aminopropylmethyldiethoxysilane, N-(β-aminoethyl)aminopropyltriisopropoxysilane, γ-ureidopropyltrimethoxysilane, N-phenyl-γ-aminopropyltrimethoxysilane, N-benzyl-γ-aminopropyltrimethoxysilane and N-vinylbenzyl-γ-aminopropyltriethoxysilane. Also, other examples of the curing catalyst encompass: silanol condensation catalysts including, for example, silane coupling agents having an amino group, such as amino-modified silyl polymers, silylated amino polymers, unsaturated aminosilane complexes, phenylamino long-chain alkylsilanes, and aminosilylated silicones, which are modified derivatives of the above curing catalysts; and other known silanol condensation catalysts including: (i) basic cataylsts; and (ii) acidic catalysts such as aliphatic acids (e.g., a ferzatic acid) and organophosphate ester compounds. One type of these curing catalysts may be used alone, or two or more types thereof may be used in combination. In particular, dioctyltin is preferable.

A content of the curing catalyst may be, for example, 0.1 parts by weight to 5 parts by weight, 0.2 parts by weight to 4 parts by weight, or 0.3 parts by weight to 3 parts by weight, with respect to a combined total of 100 parts by weight of the polyoxyalkylene-based polymer (A) and the epoxy resin (C). In a case where the content of the curing catalyst is within the above ranges, there is an advantage that both curability and reduction in cost are likely to be achieved.

### (2-9. Dehydrating Agent)

The present multi-component type curable composition may further contain a dehydrating agent. The present multi-component type curable composition containing a dehydrating agent has an advantage of having excellent storage stability.

Examples of the dehydrating agent encompass, but are not particularly limited to, vinylsilane, tosil isocyanate, vinyltrimethoxysilane, calcium oxide, zeolite, p-toluene sulfonyl isocyanate, and 3-ethyl-2-methyl-2-(3-methylbutyl)-1,3-oxazolidine. In particular, vinylsilane is preferable as the dehydrating agent because vinylsilane has an excellent balance between cost and performance. One type of these dehydrating agents may be used alone, or two or more types thereof may be used in combination.

A content of the dehydrating agent may be 0.1 parts by weight to 10 parts by weight, 0.3 parts by weight to 3.0 parts by weight, or 0.5 parts by weight to 2.0 parts by weight, with respect to a combined total of 100 parts by weight of the polyoxyalkylene-based polymer (A) and the epoxy resin (C). In a case where the content of the dehydrating agent is not less than 0.1 parts by weight with respect to 100 parts by weight of the polyoxyalkylene-based polymer (A), there is an advantage that it is possible to prevent n excess reaction of the polyoxyalkylene-based polymer (A) that reacts in the presence of water. On the other hand, in a case where the content of the dehydrating agent is not more than 3.0 parts by weight with respect to a combined total of 100 parts by weight of the polyoxyalkylene-based polymer (A) and the epoxy resin (C), there is an advantage that both of storage stability and reduction in cost are likely to be achieved.

### (2-10. Other Components)

In the present multi-component type curable composition, it is possible to add, as an additive (s) in addition to the above components, the following: a filler, an adhesiveness imparting agent, an anti-sagging agent, an antioxidant, a photo stabilizer, an ultraviolet absorbent, a tackifier resin, a low molecular weight plasticizer, other resins, and/or the like. Further, in the present multi-component type curable composition, various additives may be added as needed in order to adjust various physical properties of the curable composition or the cured product. Examples of such additives encompass solvents, diluents, photocurable substances, oxygen curable substances, surface property improving agents, silicates, curability adjusting agents, radical inhibitors, metal deactivators, antiozonants, phosphorus-based peroxide decomposition agents, lubricants, pigments, antifungal agents, flame retardants, and expanding agents.

### <Filler>

The present multi-component type curable composition can contain any of various fillers other than the inorganic filler. Examples of the filler encompass PVC powder and PMMA powder.

The amount of the filler used may be 0.5 parts by weight to 100 parts by weight, or 1 part by weight to 60 parts by weight, with respect to a combined total of 100 parts by weight of the polyoxyalkylene-based polymer (A) and the epoxy resin (C).

In order to reduce the weight (lower the specific gravity) of the multi-component type curable composition, organic balloons may be added.

### <Adhesiveness Imparting Agent>

With respect to the present multi-component type curable composition, an adhesiveness imparting agent can be added.

It is possible to add, as the adhesiveness imparting agent, a silane coupling agent or a reaction product of the silane coupling agent.

Specific examples of the silane coupling agent encompass: amino-group-containing silanes such as γ-aminopropyltrimethoxysilane, γ-aminopropylmethyldimethoxysilane, N-β-aminoethyl-γ-aminopropyltrimethoxysilane, N-β-aminoethyl-γ-aminopropylmethyldimethoxysilane, N-phenyl-γ-aminopropyltrimethoxysilane, and (2-aminoethyl)aminomethyltrimethoxysilane; isocyanate-group-containing silanes such as γ-isocyanatepropyltrimethoxysilane, γ-isocyanatepropyltriethoxysilane, γ-isocyanatepropylmethyldimethoxysilane, α-isocyanatemethyltrimethoxysilane, and α-isocyanatemethyldimethoxymethylsilane; mercapto-group-containing silanes such as γ-mercaptopropyltrimethoxysilane, γ-mercaptopropyltriethoxysilane, and γ-mercaptopropylmethyldimethoxysilane; and epoxy-group-containing silanes such as γ-glycidoxypropyltrimethoxysilane and β-(3,4-epoxycyclohexyl)ethyltrimethoxysilane.

One type of these adhesiveness imparting agents may be used alone, or two or more types thereof may be used in combination. Further, reaction products of various silane coupling agents can be used.

The amount of the silane coupling agent used may be 0.1 parts by weight to 20 parts by weight, or 0.5 parts by weight to 10 parts by weight, with respect to a combined total of 100 parts by weight of the polyoxyalkylene-based polymer (A) and the epoxy resin (C).

### <Anti-Sagging Agent>

With respect to the present multi-component type curable composition, an anti-sagging agent may be added as needed in order to prevent sagging and improve workability. Examples of the anti-sagging agent are not particularly limited, but encompass: polyamide waxes; hydrogenated castor oil derivatives; and metal soaps such as calcium stearate, aluminum stearate, and barium stearate. One type of these anti-sagging agents may be used alone, or two or more types thereof may be used in combination.

The amount of the anti-sagging agent used may be 0.1 parts by weight to 20 parts by weight, with respect to a combined total of 100 parts by weight of the polyoxyalkylene-based polymer (A) and the epoxy resin (C).

### <Antioxidant>

The present multi-component type curable composition can contain an antioxidant (anti-aging agent). Using an antioxidant makes it possible to increase the weather resistance of the cured product. Examples of the antioxidant encompass hindered phenol-based antioxidants, monophenol-based antioxidants, bisphenol-based antioxidants, and polyphenol-based antioxidants. Specific examples of the antioxidant are also disclosed in Japanese Patent Application Publication Tokukaihei No. 4-283259 and Japanese Patent Application Publication Tokukaihei No. 9-194731.

The amount of the antioxidant used may be 0.1 parts by weight to 10 parts by weight or 0.2 parts by weight to 5 parts by weight, with respect to a combined total of 100 parts by weight of the polyoxyalkylene-based polymer (A) and the epoxy resin (C).

### <Light Stabilizer>

The present multi-component type curable composition can contain a photo stabilizer. Using a light stabilizer makes it possible to prevent deterioration of the cured product due to photooxidation. Examples of the light stabilizer encompass benzotriazole-based compounds, hindered amine-based compounds, and benzoate-based compounds, and hindered amine-based compounds are particularly preferable.

The amount of the light stabilizer used may be 0.1 parts by weight to 10 parts by weight or 0.2 parts by weight to 5 parts by weight, with respect to a combined total of 100 parts by weight of the polyoxyalkylene-based polymer (A) and the epoxy resin (C).

### <Ultraviolet Absorbent>

The present multi-component type curable composition can contain an ultraviolet absorbent. Using an ultraviolet absorbent makes it possible to increase the weather resistance of the surface of the cured product. Examples of the ultraviolet absorbent encompass benzophenone-based compounds, benzotriazole-based compounds, salicylate-based compounds, substituted tolyl-based compounds, and metal chelating compounds. Benzotriazole-based compounds are particularly preferable.

Examples of commercial names of the benzotriazole-based compounds encompass Tinuvin P, Tinuvin 213, Tinuvin 234, Tinuvin 326, Tinuvin 327, Tinuvin 328, Tinuvin 329, and Tinuvin 571 (which are manufactured by BASF).

The amount of the ultraviolet absorbent used may be 0.1 parts by weight to 10 parts by weight or 0.2 parts by weight to 5 parts by weight, with respect to a combined total of 100 parts by weight of the polyoxyalkylene-based polymer (A) and the epoxy resin (C).

<Tackifier Resin>

With respect to the present multi-component type curable composition, it is possible to add a tackifier resin in order to improve adhesiveness and adhesion to a base material or according to other needs. The tackifier resin is not particularly limited, and can be a resin that is normally used as a tackifier.

Specific examples of the tackfier resin encompass: terpene-based resins; aromatic modified terpene resins; hydrogenated terpene resins; terpene-phenol resins; phenol resins; modified phenol resins; xylene-phenol resins; cyclopentadiene-phenol resins; coumarone indene resins; rosin-based resins; rosin ester resins; hydrogenated rosin ester resins; xylene resins; low molecular weight polystyrene-based resins; styrene copolymer resins; styrene-based block copolymers and hydrogenated products thereof; petroleum resins (for example, C5 hydrocarbon resin, C9 hydrocarbon resin, and C5C9 hydrocarbon copolymer resin), hydrogenated petroleum resins; and DCPD resins. One type of these tackifier resins may be used alone, or two or more types thereof may be used in combination.

The amount of the tackifier resin used may be 2 parts by weight to 100 parts by weight, 5 parts by weight to 50 parts by weight, or 5 parts by weight to 30 parts by weight, with respect to a combined total of 100 parts by weight of the polyoxyalkylene-based polymer (A) and the epoxy resin (C).

### <Low Molecular Weight Plasticizer>

With respect to the present multi-component type curable composition, a low molecular weight plasticizer can be added. The low molecular weight plasticizer may be, more specifically, diisononyl phthalate, 2-ethoxyethanol, bis(2-ethylhexyl) phthalate, diisodecyl phthalate, and the like. One type of these low molecular weight plasticizers may be used alone, or two or more types thereof may be used in combination.

A content of the low molecular weight plasticizer in the present multi-component type curable composition is not particularly limited, but may be for example, 5 parts by weight to 150 parts by weight, 20 parts by weight to 100 parts by weight, or 30 parts by weight to 80 parts by weight, with respect to a combined total of 100 parts by weight of the polyoxyalkylene-based polymer (A) and the epoxy resin (C). This feature has an advantage that both of a low viscosity of the multi-component type curable composition and a tear strength of the cured product are likely to be achieved.

### (2-11. Agent C)

With respect to the present multi-component type curable composition, water can be added as an agent C. A content of water in the present multi-component type curable composition is not particularly limited, but may be for example, 0 parts by weight to 7 parts by weight, 0.3 parts by weight to 5 parts by weight, or 0.5 parts by weight to 3 parts by weight, with respect to a combined total of 100 parts by weight of the polyoxyalkylene-based polymer (A) and the epoxy resin (C). This feature has an advantage that the multi-component type curable composition is likely to cure at a low temperature.

### (2-12. Applications)

The present multi-component type curable composition can be used for various applications including the following: waterproofing materials; architectural and industrial sealants such as construction-use elastic sealants, siding board-use sealants, insulating glass-use sealants, and vehicle-use sealants; electrical and electronic component materials such as a solar cell backside sealant; electrical insulating materials such as insulating covering materials for electric wires and cables; pressure sensitive adhesives; adhesive agents; elastic adhesive agents; contact adhesive agents; adhesive agents for tiles; reactive hot melt adhesive agents; paints; powder coating materials; coating materials; foams; sealants for can lids etc.; heat dissipation sheets; potting agents for electrical and electronic use; films; gaskets; marine deck caulking; casting materials; various molding materials; sealing materials for preventing rust or for waterproofing of edge surfaces (cut parts) of artificial marbles and wired glass or laminated glass; vibration-proofing, damping, sound-proofing, and antiseismic materials for use in automobiles, ships, and home electronics; and liquid sealants for use in, for example, automobile parts, electric parts, and various mechanical parts.

### [3. Cured Product]

One or more embodiments of the present invention provide a cured product (hereinafter referred to as “the present cured product”) which is obtained by curing the present multi-component type curable composition).

The present cured product is formed by curing the present multi-component type curable composition. In one or more embodiments of the present invention, the present cured product is formed by curing any of the following multi-component type curable compositions at room temperature without applying heat.
A multi-component type curable composition containing: an agent A that contains a component (A) and a component (B); and an agent B that contains component (C).
A multi-component type curable composition containing: an agent A that contains a component (A), a component (B), and a component (D); and an agent B that contains component (C) and a component (F).
A multi-component type curable composition containing: an agent A that contains a component (A), a component (B), a component (D), and a component (E); and an agent B that contains component (C) and a component (F).
A multi-component type curable composition containing: an agent A that contains a component (A), a component (B), a component (D), and a component (F); and an agent B that contains component (C).
A multi-component type curable composition containing: an agent A that contains a component (A), a component (B), a component (D), a component (E) and a component (F); and an agent B that contains component (C).
A multi-component type curable composition containing: an agent A that contains a component (A) and a component (B); an agent B that contains component (C); and an agent C that contains water.
A multi-component type curable composition containing: an agent A that contains a component (A), a component (B), and a component (D); an agent B that contains component (C) and a component (F); and an agent C that contains water.
A multi-component type curable composition containing: an agent A that contains a component (A), a component (B), a component (D) and a component (E); an agent B that contains component (C) and a component (F); and an agent C that contains water.
A multi-component type curable composition containing: an agent A that contains a component (A), a component (B), a component (D) and a component (F); an agent B that contains component (C); and an agent C that contains water.
A multi-component type curable composition containing: an agent A that contains a component (A), a component (B), a component (D). a component (E), and a component (F); an agent B that contains component (C); and an agent C that contains water.

The tensile elongation of the present cured product may be not less than 400%, not less than 420%, or not less than 450%. The present cured product having a tensile elongation of not less than 400% yields an effect of being unlikely to tear. It is better that the present cured product has a greater tensile elongation. Though an upper limit of the tensile elongation is not particularly limited, the upper limit is, for example, not more than 900%. Note that the tensile elongation of the present cured product can be measured by a method described in Examples below.

The tensile strength of the present cured product may be not less than 1.8 MPa, not less than 1.9 MPa, or not less than 2.0 MPa. The present cured product having a tensile strength of not less than 1.8 MPa yields an effect of being unlikely to tear. It is better that the present cured product has a greater tensile strength. Though an upper limit of the tensile strength is not particularly limited, the upper limit is, for example, not more than 10 MPa. Note that the tensile strength of the present cured product can be measured by a method described in Examples below.

The tear strength of the present cured product may be not less than 10 N/mm, not less than 12 N/mm, not less than 13 N/mm, or not less than 14 N/mm. The present cured product having a tear strength of not less than 10 N/mm yields an effect of being unlikely to tear. It is better that the present cured product has a greater tear strength. Though an upper limit of the tear strength is not particularly limited, the upper limit is, for example, not more than 40 N/mm. Note that the tear strength of the present cured product can be measured by a method described in Examples below.

### [4. Waterproofing Material]

One or more embodiments of the present invention provide a waterproofing material (hereinafter, referred to as “present waterproofing material”) containing the present cured product.

The present waterproofing material is particularly useful as a moisture-permeable waterproofing membrane coating material for roofs that require a high waterproofing performance, because the waterproofing material forms a seamless coating and has high reliability in waterproofing. The moisture-permeable waterproofing membrane coating material for roofs of buildings is a waterproofing material that is applied to a base material for a roof such as a roofing board. The present waterproofing material is not particularly limited in applications, but may be used as outdoor waterproofing materials such as ceilings, roofs, verandas, irrigation canals, or garages.

In one or more embodiments of the present invention, the present waterproofing material may contain, in addition to the present cured product, a desired component that the waterproofing material may generally contain. Such a component may be composed of one kind of ingredient or may be a combination of two or more kinds of ingredients. Further, a content of such a component is not particularly limited, and can be set as appropriate by a person skilled in the art, provided that an effect of one or more embodiments of the present invention is achieved.

### [5. Method for Producing Waterproof Construction]

One or more embodiments of the present invention provides a method for producing a waterproof construction, the method including a step of applying the present multi-component type curable composition to a base material of a building. The present multi-component type curable composition is capable of providing a cured product having an improved residual tackiness after one day. As such, the present multi-component type curable composition can rapidly advance the step of applying the multi-component type curable composition to the base material. Further, the present multi-component type curable composition makes it possible to provide a cured product that is excellent in tensile properties and tear strength. As such, the present multi-component type curable composition is capable of providing a waterproof construction having an excellent waterproofing function, by application of the present multi-component type curable composition to the base material of a building.

Examples of a method of applying the present multi-component type curable composition to the base material of a building encompass, but are not limited to, a method in which the present multi-component type curable composition is directly applied to the base material of a building and in addition, a method in which a primer is applied to the base material of a building and on the primer, the present multi-component type curable composition is applied.

One or more embodiments of the present invention also provides a method for producing a waterproof construction, the method including a step of applying a topcoat onto a coating formed by curing the present multi-component type curable composition. By applying a topcoat onto a coating that is formed by curing the present multi-component type curable composition, the waterproofing function is enhanced.

One or more embodiments of the present invention are not limited to the embodiments, but can be altered by a skilled person in the art within the scope of the claims. One or more embodiments of the present invention also encompass, in their technical scope, any embodiments derived by combining technical means disclosed in differing embodiments.

In other words, one or more embodiments of the present invention include the following.

<1> A multi-component type curable composition comprising: an agent A that contains a polyoxyalkylene-based polymer (A) having a reactive silicon group represented by general formula (1) and an epoxy resin curing agent (B) represented by general formula (2); and an agent B that contains an epoxy resin (C),

—Si(R)₃₋ₐ(X)ₐ (1)

where: each R independently represents a C1 to C20 hydrocarbon group or a triorganosiloxy group represented by —OSi(R′)₃ (where each R′ independently represents a C1 to C20 hydrocarbon group), and the hydrocarbon group represented as R may be subjected to substitution and has a hetero-containing group; each X independently represents a hydroxy group or a hydrolyzable group; and a represents an integer of 1 to 3, and

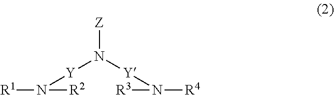

where: Z represents hydrogen, an N-containing alkyl group represented by general formula (3) below, or a C2 or higher straight-chain or branched alkyl group; R¹ to R⁴ each independently represent a straight-chain or branched alkyl group; and Y and Y′ each independently represent a straight-chain or branched alkylene group,

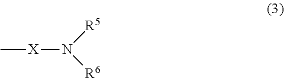

where: X represents a straight-chain or branched alkylene group; and R⁵ and R⁶ each independently represent a straight-chain or branched alkyl group.

<2> The multi-component type curable composition according to <1>, wherein the epoxy resin curing agent (B) is contained in an amount of 0.1 parts by weight to 20 parts by weight relative to a combined total of 100 parts by weight of the polyoxyalkylene-based polymer (A) and the epoxy resin (C).
<3> The multi-component type curable composition according to <1> or <2>, further comprising an inorganic filler.
<4> The multi-component type curable composition according to <3>, wherein the inorganic filler is contained in an amount of 20 parts by weight to 300 parts by weight relative to a combined total of 100 parts by weight of the polyoxyalkylene-based polymer (A) and the epoxy resin (C).
<5> The multi-component type curable composition according to any one of <1> to <4>, wherein a terminal site of the polyoxyalkylene-based polymer (A) is represented by general formula (4):

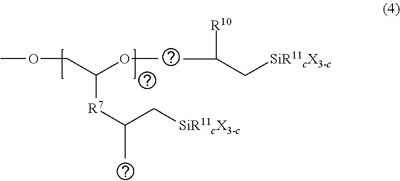

where R⁷ and R⁹ each independently represent a divalent C1-C6 bonding group, and atoms that bind to respective carbon atoms adjacent to R⁷ and R⁹ are each carbon, oxygen, or hydrogen; R⁸ and R¹⁰ each independently represent hydrogen or a C1-C10 hydrocarbon group; n represents an integer of 1 to 10; R¹¹ represents a substituted or non-substituted C1-C20 hydrocarbon group; X represents a hydroxy group or a hydrolyzable group; and c represents an integer of 1 to 3.

<6> The multi-component type curable composition according to <1> or <2>, further comprising water.
<7> A cured product produced by curing the multi-component type curable composition according to any one of <1> to <6>.
<8> A waterproofing material comprising the cured product according to <7>.
<9> A method for producing a waterproof construction, the method comprising a step of applying, to a base material of a building, the multi-component type curable composition according to any one of <1> to <6>.
<10> A method for producing a waterproof construction, the method comprising a step of applying a topcoat onto a coating formed by curing the multi-component type curable composition according to any one of <1> and <6>.

### EXAMPLES

The following description more specifically describes one or more embodiments of the present invention with reference to Examples. However, one or more embodiments of the present invention are not limited by the Examples.

### Materials

Materials used in Examples and Comparative Examples are as follows.

### <Polyoxyalkylene-Based Polymers (A)>

Polyoxyalkylene-based polymers (A-1), (A-2), (A-3), and (A-4) each having a reactive silicon group were used. The polyoxyalkylene-based polymer were produced according to Synthesis Examples below.

### <Epoxy Resin Curing Agents (B)>

Tris (3-dimethylamino) propyl)amine: (“JEFFADD (registered trademark) MW-760” manufactured by HUNTSMAN Japan KK)

Tetramethyliminobispropylamine: (“JEFFCAT (registered trademark) Z-130” manufactured by HUNTSMAN Japan KK)

<Epoxy Curing Agents Other than Epoxy Resin Curing Agents (B)>

Mixture of tris-2,4,6-(dimethylaminomethyl) phenol and bis(dimethylaminomethyl) phenol (“ANCAMINE (registered trademark) K54” manufactured by Evonik Japan Co., Ltd.)

Pentamethyl-dipropylenetriamine (“JEFFADD (registered trademark) MW-740″manufactured by HUNTSMAN Japan KK) 1-(bis(3-(dimethylamino) propyl)amino)-2-propanol (“JEFFADD (registered trademark) MW-750” manufactured by HUNTSMAN Japan KK)

1,1,4,7,10,10-hexamethyltriethylenetetramine (HMTETA) (“C3070” manufactured by Koei Chemical Co., Ltd.)

Mixture of dimethylamino (methyl) phenol and phenol (“ANCAMINE (registered trademark) 1110” manufactured by Evonik Japan Co., Ltd.)

N, N, N, N-tetramethyl-1,6-hexanediaminodiamine (“TOYOCAT-MR” manufactured by Tosoh Corporation)

Hexahydro-1,3,5-tris(3-dimethylaminopropyl)-1,3,5-triazine: (“TOYOCAT-TRC” manufactured by Tosoh Corporation)

N, N-diethyl-1,3-propanediamine (DEAPA) (“Reagent N, N-diethyl-1,3-propanediamine” manufactured by FUJIFILM Wako Pure Chemical Corporation)

### <Epoxy Resin (C)>

Bisphenol A epoxy resin (“jER 828” manufactured by Mitsubishi Chemical Corporation)

### <Aminosilane (D)>

N-(2-aminoethyl)-3-aminopropyltrimethoxysilane (“Silquest A-1120” manufactured by Momentive Performance Materials Japan LLC)

### <Mercaptan Compound (E)>

n-dodecylmercaptan (“THIOKALCOL 20” manufactured by Kao Corporation)

### <Hydroxy Group-Containing Polyoxyalkylene-Based Polymer (F)>

Polypropylene glycol resin (“ACTCOL 21-56” manufactured by Mitui Chemicals, Inc.)

### <Inorganic Fillers>

Calcium carbonate (“WHITON SB” manufactured by Shiraishi Calcium Kaisha, Ltd.)

Calcium carbonate (“NANOX #30” manufactured by Maruo Calcium Co., Ltd.)

Titanium oxide (“Titanium dioxide in sulfate process (rutile type) R-820” manufactured by “ISHIHARA SANGYO KAISHA, LTD.)

### <Curing Catalysts>

Tin catalyst (“MSCAT-01” manufactured by Nihon Kagaku Sangyo Co., Ltd.)

Tin catalyst (“NEOSTANN U-810” manufactured by Nittoh Chemical Co., Ltd.)

### <Dehydrating Agent>

Vinylsilane (“A-171” manufactured by Momentive Performance Materials Japan LLC)

### <Diluent>

Solvent (“EXXSOL D80” manufactured by Andoh Parachemie Co., Ltd.)

### <Other Components>

### (Filler)

Carbon black (“Asahi Thermal” manufactured by Asahi Carbon Co., Ltd.)

### (Water)

Ion exchange water

### (Ultraviolet Absorbent)

UVA (“TINUVIN 326” manufactured by BASF Japan Ltd.) (Hindered amine-based light stabilizer)

HALS (“TINUVIN 770DF” manufactured by BASF Japan Ltd.)

### [Measurement and Evaluation Methods]

The following describes measurement and evaluation methods in Examples and Comparative Examples.

### (Viscosity)

Parallel circular plates having a diameter of 20 mm were used as a jig. A gap was set to 0.3 mm, and the viscosity of a polymer was measured at 23° C. and at a shear rate of 1 rpm. For this measurement, a rheometer (DHR-2) manufactured by TA Instruments was used.

### (Tensile Properties)

Autograph AGS-J manufactured by Shimadzu Corporation was used and tests for tensile elongation and tensile strength were carried out at 23° C. and 50% RH. Evaluation was carried out according to evaluation described in JIS A 6021 for the urethane-based high elongation type (former class 1). Specifically, a test piece was cut out so as to have a dumbbell shape having a size of JIS Type 3. The tests for tensile elongation and tensile strength were carried out at 500 mm/min.

### (Tear Strength)

Autograph AGS-J manufactured by Shimadzu Corporation was used and tear strength was measured at 23° C. and 50% RH. Evaluation was carried out according to evaluation described in JIS A 6021 for the urethane-based high elongation type (former class 1). For the tear strength, a test piece to be used was cut out so as to be an angle-shaped dumbbell test piece without a nick, which is defined in JIS K 6252.

### (Tackiness)

The term “tackiness” refers to an evaluation of whether or not it is possible to walk on a sheet in order to carry out recoating in a next step. The tackiness was evaluated in accordance with the following criteria, and an evaluation of “B” or higher was determined to be a level at which it was possible to walk on the sheet.

AA: Not at all tacky at the time when a palm is pressed against the sheet with a body weight.

A: Not at all tacky at the time when a palm is pressed against the sheet.

B: Slightly tacky at the time when a palm of a hand is pressed against the sheet (the sheet peels off when the hand pressed against the sheet is moved upward)

C: Lightly tacky at the time when a palm of a hand is pressed against a sheet (the sheet peels off after a while, when the hand pressed against the sheet is moved upward)

D: Tacky at the time when a palm of a hand is pressed against a sheet (the sheet does not peel off when the hand pressed against the sheet is moved upward)

### (Odor Intensity)

The solution A (agent A) and the solution B (agent B) for each sample were mixed at a defined ratio, and 0.07 g of each mixture was put in a 20-ml vial and was tightly stoppered. Thereafter, an odor evaluation of a gas phase portion of the vial was carried out by two licensed smell examiners, in accordance with a scale of odor intensity below.
5: Very strong odor
4: Strong odor
3: Easily sensed odor
2: Distinct but weak odor
1: Barely sensed odor
0: No odor

### Synthesis Example 1

### The Following Describes a Synthesis Example of the Polyoxyalkylene-Based Polymer (A-1).

Propylene oxide was polymerized with use of (i) polyoxypropylene triol having a number average molecular weight of approximately 4,500 as an initiator and (ii) a zinc hexacyanocobaltate glyme complex catalyst. As a result, a hydroxy group-terminated polyoxypropylene (P-1) was obtained having a number average molecular weight of 24,600 (terminal group equivalent molecular weight of 17,400) and a molecular weight distribution Mw/Mn of 1.31. With respect to a hydroxy group of the hydroxy group-terminated polyoxypropylene (P-1) obtained, 1.2 molar equivalents of sodium methoxide was added as a 28% methanol solution. The methanol was distilled away by vacuum devolatilization, and then, with respect to the hydroxy group of the polymer (P-1), 1.5 molar equivalents of allyl chloride was added to convert the hydroxy group at a terminal to an allyl group. Devolatilization was carried out under reduced pressure to remove unreacted allyl chloride. A resulting unrefined polyoxypropylene was mixed and stirred with n-hexane and water. Then, the water was removed by centrifugal separation. Thereafter, devolatilization of hexane from a resulting hexane solution was carried out under reduced pressure. Thus, a metal salt in the polymer was removed. In this way, an allyl group-terminated polyoxypropylene (Q-1) was obtained. To 500 g of this polymer (Q-1), 50 μl of a platinum-divinyldisiloxane complex solution (3% by weight of isopropanol solution in platinum equivalent) was added. Then, 6.4 g of dimethoxymethylsilane was slowly dripped while stirring was being carried out. After a reaction at 100° C. for 2 hours was carried out, unreacted dimethoxymethylsilane was distilled away under reduced pressure. Thus obtained was a dimethoxymethylsilyl group-terminated polyoxypropylene (A-1) that had a number average molecular weight of 26,200. It was found that the polymer (A-1) had 0.7 dimethoxymethylsilyl groups per terminal on average and 2.2 dimethoxymethylsilyl groups per molecule on average. The viscosity of the polymer (A-1) was 24 Pa·s.

### Synthesis Example 2

### The Following Describes a Synthesis Example of the Polyoxyalkylene-Based Polymer (A-2).

Propylene oxide was polymerized with use of (i) polyoxy propylene glycol having a number average molecular weight of approximately 4,800 as an initiator and (ii) a zinc hexacyanocobaltate glyme complex catalyst. As a result, a polyoxypropylene (P-2) having hydroxy groups at both terminals was obtained having a number average molecular weight of 28,000 (terminal group equivalent molecular weight of 18,000) and a molecular weight distribution Mw/Mn of 1.21. Next, with respect to the hydroxy groups of this hydroxy group-terminated polyoxypropylene (P-2) obtained, 1.0 molar equivalent of sodium methoxide was added as a 28% methanol solution. The methanol was distilled away by vacuum devolatilization, and then 1.0 molar equivalent of an allyl glycidyl ether was added with respect to the hydroxy groups of the polymer (P-2). A resultant mixture was caused to react at 130° C. for 2 hours. Next, a methanol solution containing 0.28 molar equivalents of sodium methoxide was added and methanol was removed. Then, 1.79 molar equivalents of allyl chloride was further added to convert the hydroxy groups at the terminals to allyl groups. A resulting unrefined polyoxypropylene was mixed and stirred with n-hexane and water. Then, the water was removed by centrifugal separation. Thereafter, devolatilization of hexane from a resulting hexane solution was carried out under reduced pressure. Thus, a metal salt in the polymer was removed. In this way, a polyoxypropylene (Q-2) having a plurality of carbon-carbon unsaturated bonds at the terminals was obtained. It was found that 2.0 carbon-carbon unsaturated bonds per terminal on average were introduced to the polymer (Q-2).

To 500 g of the polymer (Q-2) obtained, 50 μl of a platinum-divinyldisiloxane complex solution (3% by weight of isopropanol solution in platinum equivalent) was added. Then, 9.6 g of dimethoxymethylsilane was slowly dripped while stirring was being carried out. After a reaction at 100° C. for 2 hours of a mixture solution thus obtained was carried out, unreacted dimethoxymethylsilane was distilled away under reduced pressure. Thus obtained was a polyoxypropylene (A-2) that had a number average molecular weight of 28, 500 and that had a plurality of dimethoxymethylsilyl groups at the terminals. It was found that the polyoxyalkylene-based polymer (A-2) had 1.7 dimethoxymethylsilyl groups per terminal on average and 3.4 dimethoxymethylsilyl groups per molecule on average. The viscosity of the polymer (A-2) was 46 Pa·s.

### Synthesis Example 3

The following describes a synthesis example of the polyoxyalkylene-based polymer (A-3).

Propylene oxide was polymerized with use of (i) butanol as an initiator and (ii) a zinc hexacyanocobaltate glyme complex catalyst. As a result, a polyoxypropylene (P-3) having a hydroxy group at one terminal was obtained having a number average molecular weight of 7,800 (terminal group equivalent molecular weight of 5,000) and a molecular weight distribution Mw/Mn of 1.48. Next, with respect to the hydroxy group of this hydroxy group-terminated polyoxypropylene (P-3) obtained, 1.2 molar equivalents of sodium methoxide was added as a 28% methanol solution. The methanol was distilled away by vacuum devolatilization, and then, with respect to the hydroxy group of the polymer (P-3), 2.0 molar equivalents of allyl chloride was added to convert the hydroxy group at the terminal to an allyl group. Then, devolatilization was carried out under reduced pressure to remove unreacted allyl chloride. A resulting unrefined polyoxypropylene was mixed and stirred with n-hexane and water. Then, the water was removed by centrifugal separation. Thereafter, devolatilization of hexane from a resulting hexane solution was carried out under reduced pressure. Thus, a metal salt in the polymer was removed. In this way, a polyoxypropylene (Q-3) having an allyl group at only one terminal was obtained. To 500 g of the polymer (Q-3) obtained, 50 μl of a platinum-divinyldisiloxane complex (3% by weight of 2-propanol solution in platinum equivalent) was added. Then, 9.5 g of dimethoxymethylsilane was slowly dripped while stirring was being carried out. After a reaction at 100° C. for 2 hours of a mixture solution thus obtained was carried out, unreacted dimethoxymethylsilane was distilled away under reduced pressure. Thus obtained was a polyoxypropylene (A-3) that had a dimethoxymethylsilyl group at only one terminal. It was found that the polyoxyalkylene-based polymer (A-3) had 0.8 dimethoxymethylsilyl groups on average at only one terminal. The viscosity of the polymer (A-3) was 2.5 Pa·s.

### Synthesis Example 4

The following describes a synthesis example of the polyoxyalkylene-based polymer (A-4).

Propylene oxide was polymerized with use of (i) polyoxy propylene glycol having a number average molecular weight of approximately 4,500 as an initiator and (ii) a zinc hexacyanocobaltate glyme complex catalyst. As a result, a polyoxypropylene (P-4) having hydroxy groups at both terminals was obtained having a number average molecular weight of 20,900 (terminal group equivalent molecular weight of 13,600) and a molecular weight distribution Mw/Mn of 1.23. Next, with respect to the hydroxy groups of the hydroxy group-terminated polyoxypropylene (P-4) obtained, 1.0 molar equivalent of sodium methoxide was added as a 28% methanol solution. With respect to the hydroxy groups of the polymer (P-4), 0.3 molar equivalents of an allyl glycidyl ether was added and a resultant mixture was caused to react at 130° C. for 2 hours. Next, a methanol solution containing 0.28 molar equivalents of sodium methoxide was added and the methanol was removed. Then, 1.79 molar equivalents of allyl chloride was further added to convert the hydroxy groups at the terminals to allyl groups. Then, devolatilization was carried out under reduced pressure to remove unreacted allyl chloride. A resulting unrefined polyoxypropylene was mixed and stirred with n-hexane and water. Then, the water was removed by centrifugal separation. Thereafter, devolatilization of hexane from a resulting hexane solution was carried out under reduced pressure. Thus, a metal salt in the polymer was removed. In this way, a polyoxypropylene (Q-4) having a plurality of carbon-carbon unsaturated bonds at the terminals was obtained. It was found that 1.29 carbon-carbon unsaturated bonds per terminal on average were introduced to the polymer (Q-4).

To 500 g of the polymer (Q-4) obtained, 50 μl of a platinum-divinyldisiloxane complex (3% by weight of 2-propanol solution in platinum equivalent) was added. Then, 7.4 g of dimethoxymethylsilane was slowly dripped while stirring was being carried out. After a reaction at 90° C. for 2 hours of a mixture thus obtained was carried out, unreacted dimethoxymethylsilane was distilled away under reduced pressure. Thus obtained was a polyoxypropylene (A-4) that had a number average molecular weight of 22,000 and that had a plurality of dimethoxymethylsilyl groups at the terminals. It was found that the polymer (A-4) had 0.99 dimethoxymethylsilyl groups per terminal on average and 1.98 dimethoxymethylsilyl groups per molecule on average. The viscosity of the polymer (A-4) was 16 Pa·s.

### Example 1

The following materials were added in respective amounts indicated in Table 1: (A-2), and (A-1), (A-3) as a polyoxyalkylene-based polymer (A) having a reactive silicon group; JEFFADD (registered trademark) MW-760 as an epoxy resin curing agent (B); DEAPA as an epoxy resin curing agent other than the epoxy resin curing agent (B); A-1120 as aminosilane (D); THIOKALCOL 20 as the mercaptan compound (E); vinylsilane A-171 as the dehydrating agent; and MSCAT-01 as the curing catalyst. Then, manual stirring was carried out for 2 minutes to prepare a solution A (agent A).

The following substances were added in respective amounts indicated in Table 1: jER 828 as an epoxy resin (C); ACTCOL 21-56 as a hydroxy group-containing polyoxyalkylene-based polymer (F); calcium carbonate (WHITON SB) as an inorganic filler; and carbon black (Asahi Thermal) as a filler. Then, manual stirring was carried out for 2 minutes. Subsequently, a resulting mixture was caused to pass ceramic triple roll three times, so that a solution B (agent B) was prepared.

Next, in respective amounts indicated in Table 1, the solution A (agent A), the solution B (agent B), and a solution C (agent C) were sequentially added in a disposable cup, and manual stirring was carried out. Thereafter, mixing and deaeration were carried out by a super mixer (ARE-250, manufactured by THINKY CORPORATION). Specifically, the mixing and deaeration were carried out by performing stirring at 500 rpm for 20 seconds, at 1500 rpm for 20 seconds, and at 2000 rpm for 40 seconds and then deaeration at 1500 rpm for 40 seconds. Subsequently, a resultant mixture having been subjected to the deaeration was caused to flow into a mold (Teflon (registered trademark) sheet+backer, thickness: 2 mm).

These operations were carried out so as to be completed within 2 hours.

Thereafter, curing and aging were carried out under conditions of 23° ° C. and 50% RH. The tensile properties and tear strength were evaluated for cured products obtained by seven-day curing and aging. The tackiness was evaluated for cured products obtained by one-day curing and aging and seven-day curing and aging. Table 1 shows results of such evaluation.

### Examples 2 to 21

Curable resin compositions and cured products were prepared by procedures similar to those used in Example 1, except that the respective amounts of components mixed were changed to those described in Table 1. TINUVIN 326, which was an ultraviolet absorbent, and TINUVIN 770DF, which was a hindered amine-based light stabilizer, were dissolved in ACTCOL 21-56 of a hydroxy group-containing polyoxyalkylene-based polymer (F) at 80° C., and then added. Resulting cured products were evaluated for tackiness, tensile properties, and tear strength. Table 1 shows results of such evaluation.

TABLE 1

| | | | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | Compound | | 1 | 2 | 3 | 4 | 5 | 6 | 7 | 8 | 9 | 10 | 11 | 12 |
| Agent | Polyoxyalkylene- | A-1 | 10 | 10 | | 10 | 10 | 10 | 10 | 10 | 10 | | | |
| A | based | A-2 | 50 | 50 | | 50 | 50 | 50 | 50 | 50 | 50 | | | |
| | polymers (A) | A-3 | 10 | 10 | | 10 | 10 | 10 | 10 | 10 | 10 | | | |
| | | A-4 | | | 70 | | | | | | | 70 | 70 | 70 |
| | Epoxy resin | MW-760 | 6.0 | 6.0 | 8.0 | 6.0 | 6.0 | 8.0 | | 6.0 | | 7.0 | 7.0 | 7.0 |
| | curing agents | JEFFCAT Z-130 | | | | | | | 6.0 | | 6.0 | | | |
| | (B) | | | | | | | | | | | | | |
| | Epoxy curing | Ancamine 54K | | | | | | | | | | | | |
| | agents other | MW-740 | | | | | | | | | | | | |
| | than epoxy | MW-750 | | | | | | | | | | | | |
| | resin curing | C3070 | | | | | | | | | | | | |
| | agents (B) | Ancamine 1110 | | | | | | | | | | | | |
| | | TOYOCAT-MR | | | | | | | | | | | | |
| | | TOYOCAT-TRC | | | | | | | | | | | | |
| | | DEAPA | 1 | 1 | 1 | 1 | | 1 | 1 | 1 | 1 | 1 | 1 | 1 |
| | Aminosilane (D) | A-1120 | 1.0 | 1.0 | 1.0 | 1.0 | 1.0 | 1.0 | 1.0 | 1.0 | 1.0 | 1.0 | 1.0 | 1.0 |
| | Mercaptan | THIOKALCOL 20 | 0.3 | | | 0.3 | 0.3 | 0.3 | 0.3 | | | | | |
| | compound (E) | | | | | | | | | | | | | |
| | Vinylsilane | A-171 | 0.5 | 0.5 | 0.5 | 0.5 | 0.5 | 0.5 | 0.5 | 0.5 | 0.5 | 0.5 | 0.5 | 0.5 |
| | Curing catalyst | MSCAT-01 | 0.7 | 0.7 | 0.7 | | | | | | | | | 0.7 |
| | | U810 | | | | | | | | | | 1.5 | 0.7 | |
| | Diluent | D80 | | | | | | | | | | 5 | 5 | 5 |
| | Total | | 80 | 79 | 81 | 79 | 78 | 81 | 79 | 79 | 79 | 86 | 85 | 85 |
| Agent | Epoxy resin | jER 828 | 35 | 35 | 35 | 35 | 35 | 35 | 35 | 35 | 35 | 35 | 35 | 35 |
| B | (C) | | | | | | | | | | | | | |
| | Hydroxy group- | ACTCOL 21-56 | 25 | 25 | 25 | 25 | 25 | 25 | 25 | 25 | 25 | 36 | 36 | 36 |
| | containing | | | | | | | | | | | | | |
| | polyoxyalkylene- | | | | | | | | | | | | | |
| | based polymer | | | | | | | | | | | | | |
| | (F) | | | | | | | | | | | | | |
| | Vinylsilane | A-171 | | | | 0.5 | 0.5 | 0.5 | 0.5 | 0.5 | 0.5 | | | |
| | Curing catalyst | MSCAT-01 | | | | 0.7 | 0.7 | 0.7 | 0.7 | 0.7 | 0.7 | | | |
| | Calcium | WHITON SB | 75 | 75 | 65 | 75 | 75 | 75 | 75 | 75 | 75 | 65 | 65 | 65 |
| | carbonate | | | | | | | | | | | | | |
| | Calcium | NANOX #30 | | | | | | | | | | | | |
| | carbonate | | | | | | | | | | | | | |
| | Titanium oxide | R820 | | | | | | | | | | | | |
| | Carbon black | AsahiThermal | 0.1 | 0.1 | 0.1 | 0.1 | 0.1 | 0.1 | 0.1 | 0. | 0.1 | 0.1 | 0.1 | 0.1 |
| | UVA | T326 | | | | | | | | | | | | |
| | HALS | T770 | | | | | | | | | | | | |
| | Water | Ion exchange | | | | | | | | | | 0.5 | 0.5 | 0.5 |
| | | water | | | | | | | | | | | | |
| | Total | | 135 | 135 | 125 | 136 | 136 | 136 | 136 | 136 | 136 | 137 | 137 | 137 |
| A + B | Total | | 215 | 214 | 206 | 215 | 214 | 217 | 215 | 215 | 215 | 223 | 222 | 222 |
| Agent | Water | Ion exchange | 0.5 | 0.5 | 0.5 | | | | | | | | | |
| C | | water | | | | | | | | | | | | |

| Tensile properties | Tensile | 560 | 485 | 614 | 550 | 553 | 524 | 630 | 603 | 550 | 674 | 578 | 735 |
|---|---|---|---|---|---|---|---|---|---|---|---|---|---|
| | elongation (%) | | | | | | | | | | | | |
| | Tensile strength | 3.0 | 3.3 | 2.6 | 2.5 | 2.6 | 2.5 | 2.1 | 2.9 | 2.4 | 2.1 | 2.1 | 2.4 |
| | (MPa) | | | | | | | | | | | | |
| Tear strength (N/mm) | | 23.1 | 22.6 | 22.6 | 17.5 | 16.1 | 21 | 14.8 | 23.4 | 17.3 | 16.0 | 16.0 | 18.0 |
| Tackeness | One day | B | A | B | B | B | A | A | A | A | AA | AA | B |
| | Seven days | AA | AA | AA | AA | AA | AA | AA | AA | AA | AA | AA | AA |

| | |
|---|---|
| Odor strength | 1.3 |

| | | | Ex. | Ex. | Ex. | Ex. | Ex. | Ex. | Ex. | Ex. | Ex. |
|---|---|---|---|---|---|---|---|---|---|---|---|
| | Compound | | 13 | 14 | 15 | 16 | 17 | 18 | 19 | 20 | 21 |
| Agent | Polyoxyalkylene- | A-1 | 10 | 10 | 10 | 10 | 10 | 10 | 10 | 10 | 10 |
| A | based | A-2 | 50 | 50 | 50 | 50 | 50 | 50 | 50 | 50 | 50 |
| | polymers (A) | A-3 | 20 | 20 | 20 | 20 | 20 | 20 | 20 | 20 | 20 |
| | | A-4 | | | | | | | | | |
| | Epoxy resin | MW-760 | 3.0 | 5.0 | 8.0 | 12.0 | 18.0 | 5.0 | 5.0 | 5.0 | 5.0 |
| | curing agents | JEFFCAT Z-130 | | | | | | | | | |
| | (B) | | | | | | | | | | |
| | Epoxy curing | Ancamine 54K | | | | | | | | | |
| | agents other | MW-740 | | | | | | | | | |
| | than epoxy | MW-750 | | | | | | | | | |
| | resin curing | C3070 | | | | | | | | | |
| | agents (B) | Ancamine 1110 | | | | | | | | | |
| | | TOYOCAT-MR | | | | | | | | | |
| | | TOYOCAT-TRC | | | | | | | | | |
| | | DEAPA | 2 | 2 | 2 | 2 | 2 | 2 | 2 | 2 | 2 |
| | Aminosilane (D) | A-1120 | 1.0 | 1.0 | 1.0 | 1.0 | 1.0 | 1.0 | 1.0 | 1.0 | 1.0 |
| | Mercaptan | THIOKALCOL 20 | | | | | | | | | |
| | compound (E) | | | | | | | | | | |
| | Vinylsilane | A-171 | 1.0 | 1.0 | 1.0 | 1.0 | 1.0 | 1.0 | 1.0 | 1.0 | 1.0 |
| | Curing catalyst | MSCAT-01 | | | | | | | | | |
| | | U810 | 1.5 | 1.5 | 1.5 | 1.5 | 1.5 | 1.5 | 1.5 | 1.5 | 1.5 |
| | Diluent | D80 | 15 | 15 | 15 | 15 | 15 | 15 | 15 | 15 | 15 |
| | Total | | 104 | 106 | 109 | 113 | 119 | 106 | 106 | 106 | 106 |
| Agent | Epoxy resin | jER 828 | 35 | 35 | 35 | 35 | 35 | 35 | 35 | 35 | 35 |
| B | (C) | | | | | | | | | | |
| | Hydroxy group- | ACTCOL 21-56 | 26 | 26 | 26 | 26 | 26 | 26 | 26 | 26 | 26 |
| | containing | | | | | | | | | | |
| | polyoxyalkylene- | | | | | | | | | | |
| | based polymer | | | | | | | | | | |
| | (F) | | | | | | | | | | |
| | Vinylsilane | A-171 | | | | | | | | | |
| | Curing catalyst | MSCAT-01 | | | | | | | | | |
| | Calcium | WHITON SB | 45 | 45 | 45 | 45 | 45 | 25 | 140 | 190 | |
| | carbonate | | | | | | | | | | |
| | Calcium | NANOX #30 | | | | | | | | | 45 |
| | carbonate | | | | | | | | | | |
| | Titanium oxide | R820 | 10 | 10 | 10 | 10 | 10 | 10 | 10 | 10 | 10 |
| | Carbon black | AsahiThermal | 0.1 | 0.1 | 0.1 | 0.05 | 0.05 | 0.1 | 0.1 | 0.1 | 0.1 |
| | UVA | T326 | 1 | 1 | 1 | 1 | 1 | 1 | 1 | 1 | 1 |
| | HALS | T770 | 0.5 | 0.5 | 0.5 | 0.5 | 0.5 | 0.5 | 0.5 | 0.5 | 0.5 |
| | Water | Ion exchange | 0.5 | 0.5 | 0.5 | 0.5 | 0.5 | 0.5 | 0.5 | 0.5 | 0.5 |
| | | water | | | | | | | | | |
| | Total | | 118 | 118 | 118 | 118 | 118 | 98 | 213 | 263 | 118 |
| A + B | Total | | 222 | 224 | 227 | 231 | 237 | 204 | 319 | 369 | 224 |
| Agent | Water | Ion exchange | | | | | | | | | |
| C | | water | | | | | | | | | |

| Tensile properties | Tensile | 661 | 680 | 739 | 806 | 915 | 800 | 271 | 185 | 793 |
|---|---|---|---|---|---|---|---|---|---|---|
| | elongation (%) | | | | | | | | | |
| | Tensile strength | 2.6 | 2.4 | 2.5 | 2.3 | 1.9 | 2.9 | 2.3 | 2.3 | 3.4 |
| | (MPa) | | | | | | | | | |
| Tear strength (N/mm) | | 10.8 | 14.5 | 19.1 | 16.0 | 12.9 | 17.2 | 12.1 | 10.6 | 22.5 |
| Tackeness | One day | AA | AA | AA | AA | AA | AA | AA | AA | AA |

| | | | | | | | | | |
|---|---|---|---|---|---|---|---|---|---|
| Seven days | AA | AA | AA | AA | AA | AA | AA | AA | AA |

Odor strength

Note:
“Example” is abbreviated as “Ex.”

### Comparative Examples 1 to 12

Curable resin compositions and cured products were prepared by procedures similar to those used in Example 1, except that the respective amounts of components mixed were changed to those described in Table 2. Resulting cured products were evaluated for tackiness, tensile properties, and tear strength. Table 2 shows results of such evaluation.

TABLE 2

| | | | Co. | Co. | Co. | Co. | Co. | Co. | Co. |
|---|---|---|---|---|---|---|---|---|---|
| | Compound | | Ex. 1 | Ex. 2 | Ex. 3 | Ex. 4 | Ex. 5 | Ex. 6 | Ex. 7 |
| Agent | Polyoxyalkylene- | A-1 | 10 | 10 | 10 | 10 | 10 | 10 | 10 |
| A | based | A-2 | 50 | 50 | 50 | 50 | 50 | 50 | 50 |
| | polymers (A) | A-3 | 10 | 10 | 10 | 10 | 10 | 10 | 10 |
| | | A-4 | | | | | | | |
| | Epoxy resin | MW-760 | | | | | | | |
| | curing agents | JEFFCAT Z-130 | | | | | | | |
| | (B) | | | | | | | | |
| | Epoxy curing | Ancamine 54K | 6.0 | 6.0 | 6.0 | | | | |
| | agents other | MW-740 | | | | 6.0 | | | |
| | than epoxy | MW-750 | | | | | 6.0 | | |
| | resin curing | C3070 | | | | | | 6.0 | |
| | agents (B) | Ancamine 1110 | | | | | | | 6.0 |
| | | TOYOCAT-MR | | | | | | | |
| | | TOYOCAT-TRC | | | | | | | |
| | | DEAPA | 1 | 1 | 1 | 1 | 1 | 1 | 1 |
| | Aminosilane (D) | A-1120 | 1.0 | 1.0 | 1.0 | 1.0 | 1.0 | 1.0 | 1.0 |
| | Mercaptan | THIOKALCOL 20 | 0.3 | | 0.3 | 0.3 | 0.3 | 0.3 | 0.3 |
| | compound (E) | | | | | | | | |
| | Vinylsilane | A-171 | 0.5 | 0.5 | 0.5 | 0.5 | 0.5 | 0.5 | 0.5 |
| | Curing catalyst | MSCAT-01 | 0.7 | 0.7 | | | | | |
| | | U810 | | | | | | | |
| | Diluent | D80 | | | | | | | |
| | Total | | 79.5 | 79.2 | 78.8 | 78.8 | 78.8 | 78.8 | 78.8 |
| Agent | Epoxy resin | jER 828 | 35 | 35 | 35 | 35 | 35 | 35 | 35 |
| B | (C) | | | | | | | | |
| | Hydroxy group- | ACTCOL 21-56 | 25 | 25 | 25 | 25 | 25 | 25 | 25 |
| | containing | | | | | | | | |
| | polyoxyalkylene- | | | | | | | | |
| | based polymer | | | | | | | | |
| | (F) | | | | | | | | |
| | Vinylsilane | A-171 | | | 0.5 | 0.5 | 0.5 | 0.5 | 0.5 |
| | Curing catalyst | MSCAT-01 | | | 0.7 | 0.7 | 0.7 | 0.7 | 0.7 |
| | Calcium | WHITON SB | 75 | 75 | 75 | 75 | 75 | 75 | 75 |
| | carbonate | | | | | | | | |
| | Calcium | NANOX #30 | | | | | | | |
| | carbonate | | | | | | | | |
| | Titanium oxide | R820 | | | | | | | |
| | Carbon black | AsahiThermal | 0.05 | 0.05 | 0.05 | 0.05 | 0.05 | 0.05 | 0.05 |
| | UVA | T326 | | | | | | | |
| | HALS | T770 | | | | | | | |
| | Water | Ion exchange | | | | | | | |
| | | water | | | | | | | |
| | Total | | 135 | 135 | 136 | 136 | 136 | 136 | 136 |
| A + B | Total | | 215 | 214 | 215 | 215 | 215 | 215 | 215 |
| Agent | Water | Ion exchange | 0.5 | 0.5 | | | | | |
| C | | water | | | | | | | |

| Tensile properties | Tensile | 392 | 409 | 442 | 646 | 740 | 556 | 372 |
|---|---|---|---|---|---|---|---|---|
| | elongation (%) | | | | | | | |
| | Tensile strength | 3.9 | 3.5 | 3.0 | 1.8 | 2.1 | 1.7 | 2.7 |
| | (MPa) | | | | | | | |
| Tear strength (N/mm) | | 24.0 | 18.6 | 18.7 | 13.7 | 15.1 | 12.7 | 9.1 |
| Tackeness | One day | D | C | D | C | D | C | D |
| | Seven days | C | B | C | AA | AA | AA | C |

Odor strength

| | | | Co. | Co. | Co. | Co. | Co. |
|---|---|---|---|---|---|---|---|
| | Compound | | Ex. 8 | Ex. 9 | Ex. 10 | Ex. 11 | Ex. 12 |
| Agent | Polyoxyalkylene- | A-1 | 10 | 10 | 10 | | 10 |
| A | based | A-2 | 50 | 50 | 50 | | 50 |
| | polymers (A) | A-3 | 10 | 10 | 10 | | 20 |
| | | A-4 | | | | 70 | |
| | Epoxy resin | MW-760 | | | | | |
| | curing agents | JEFFCAT Z-130 | | | | | |
| | (B) | | | | | | |
| | Epoxy curing | Ancamine 54K | | | | 7.0 | |
| | agents other | MW-740 | | | | | |
| | than epoxy | MW-750 | | | | | |
| | resin curing | C3070 | | | | | |
| | agents (B) | Ancamine 1110 | | | | | |
| | | TOYOCAT-MR | 6.0 | | | | |
| | | TOYOCAT-TRC | | 6.0 | | | |
| | | DEAPA | 1 | 1 | 6.0 | 1 | 2 |
| | Aminosilane (D) | A-1120 | 1.0 | 1.0 | 1.0 | 1.0 | 1.0 |
| | Mercaptan | THIOKALCOL 20 | 0.3 | 0.3 | 0.3 | | |
| | compound (E) | | | | | | |
| | Vinylsilane | A-171 | 0.5 | 0.5 | 0.5 | 0.5 | 1.0 |
| | Curing catalyst | MSCAT-01 | | | | | |
| | | U810 | | | | 1.5 | 1.5 |
| | Diluent | D80 | | | | 5 | 15 |
| | Total | | 78.8 | 78.8 | 77.8 | 86 | 101 |
| Agent | Epoxy resin | jER 828 | 35 | 35 | 35 | 35 | 35 |
| B | (C) | | | | | | |
| | Hydroxy group- | ACTCOL 21-56 | 25 | 25 | 25 | 36 | 26 |
| | containing | | | | | | |
| | polyoxyalkylene- | | | | | | |
| | based polymer | | | | | | |
| | (F) | | | | | | |
| | Vinylsilane | A-171 | 0.5 | 0.5 | 0.5 | | |
| | Curing catalyst | MSCAT-01 | 0.7 | 0.7 | 0.7 | | |
| | Calcium | WHITON SB | 75 | 75 | 75 | 65 | 45 |
| | carbonate | | | | | | |
| | Calcium | NANOX #30 | | | | | |
| | carbonate | | | | | | |
| | Titanium oxide | R820 | | | | | 10 |
| | Carbon black | AsahiThermal | 0.05 | 0.05 | 0.05 | 0.05 | 0.05 |
| | UVA | T326 | | | | | 1 |
| | HALS | T770 | | | | | 0.5 |
| | Water | Ion exchange | | | | 0.5 | 0.5 |
| | | water | | | | | |
| | Total | | 136 | 136 | 136 | 137 | 118 |
| A + B | Total | | 215 | 215 | 214 | 223 | 219 |
| Agent | Water | Ion exchange | | | | | |
| C | | water | | | | | |

| Tensile properties | Tensile | 770 | 630 | 443 | 522 | 695 |
|---|---|---|---|---|---|---|
| | elongation (%) | | | | | |
| | Tensile strength | 2.2 | 2.4 | 3.0 | 3.2 | 2.5 |
| | (MPa) | | | | | |
| Tear strength (N/mm) | | 15.8 | 15.4 | 12.1 | 16.0 | 8.3 |
| Tackeness | One day | C | C | C | C | D |

| | | | | | |
|---|---|---|---|---|---|
| Seven days | AA | AA | B | B | C |

| | |
|---|---|
| Odor strength | 3.0 |

Note:
“Comparative Example” is abbreviated as “Co. Ex.”

### [Results]

Tables 1 and 2 showed that the curable compositions of Examples 1 to 21 were excellent in tackiness when formed into the cured products. In other words, it was demonstrated that one or more embodiments of the present invention could provide a multi-component type curable composition that was capable of providing a cured product having an improved residual tackiness after one day. It was also demonstrated that the curable compositions in Examples 1 to 21 were excellent in tensile properties and tear strength when formed into the cured products.

In contrast, in the cases of the curable compositions of Comparative Examples 1 to 12, the tackiness, the tensile properties, and the tear strength were poor. In other words, it was demonstrated that in cases where the curable compositions did not satisfy the feature of the present multi-component type curable composition, the residual tackiness after one day (further, tensile properties and tear strength) became poor. In addition, it was clear from a comparison between Example 10 and Comparative Example 11 that the odor of the curable compositions of Examples was reduced by mixing a specific epoxy resin curing agent.

The present multi-component type curable composition can be suitably used for a waterproofing material etc. since the multi-component type curable composition is capable of providing a cured product having an improved residual tackiness after one day.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A multi-component type curable composition comprising:
an agent A containing a polyoxyalkylene-based polymer (A) having a reactive silicon group represented by general formula (1) and an epoxy resin curing agent (B) represented by general formula (2); and
an agent B containing an epoxy resin (C),
wherein the general formula (1) is
—Si(R)₃₋ₐ(X)ₐ (1)
where each R independently represents a C1 to C20 hydrocarbon group or a triorganosiloxy group represented by —OSi(R′)₃, where each R′ independently represents a C1 to C20 hydrocarbon group, and the C1 to C20 hydrocarbon group represented as R is optionally substituted and has a hetero-containing group; each X independently represents a hydroxy group or a hydrolyzable group; and a represents an integer of 1 to 3,
wherein the general formula (2) is 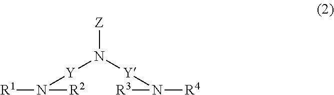
where Z represents hydrogen, an N-containing alkyl group represented by general formula (3) below, or a C2 or higher straight-chain alkyl group or a C2 or higher branched alkyl group; R¹ to R⁴ each independently represent a straight-chain alkyl group or branched alkyl group; and Y and Y′ each independently represent a straight-chain alkylene group or branched alkylene group, and
wherein the general formula (3) is 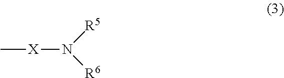
where X represents a straight-chain alkylene group or branched alkylene group; and R⁵ and R⁶ each independently represent a straight-chain alkyl group or branched alkyl group.

2. The multi-component type curable composition according to claim 1, wherein the epoxy resin curing agent (B) is contained in an amount of 0.1 parts by weight to 20 parts by weight relative to a combined total of 100 parts by weight of the polyoxyalkylene-based polymer (A) and the epoxy resin (C).

3. The multi-component type curable composition according to claim 1, further comprising an inorganic filler.

4. The multi-component type curable composition according to claim 3, wherein the inorganic filler is contained in an amount of 20 parts by weight to 300 parts by weight relative to a combined total of 100 parts by weight of the polyoxyalkylene-based polymer (A) and the epoxy resin (C).

5. The multi-component type curable composition according to claim 1, wherein a terminal site of the polyoxyalkylene-based polymer (A) is represented by general formula (4): 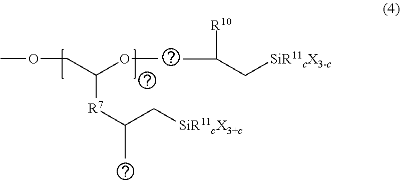
where R⁷ and R⁹ each independently represent a divalent C1-C6 bonding group, and atoms that bind to respective carbon atoms adjacent to R⁷ and R⁹ are each carbon, oxygen, or hydrogen;
R⁸ and R¹⁰ each independently represent hydrogen or a C1-C10 hydrocarbon group;
n represents an integer of 1 to 10;
R¹¹ represents a substituted or non-substituted C1-C20 hydrocarbon group;
X represents a hydroxy group or a hydrolyzable group; and
c represents an integer of 1 to 3.

6. The multi-component type curable composition according to claim 1, further comprising water.

7. A cured product produced by curing the multi-component type curable composition according to claim 1.

8. A waterproofing material comprising the cured product according to claim 7.

9. A method for producing a waterproof construction, the method comprising a step of applying, to a base material of a building, the multi-component type curable composition according to claim 1.

10. A method for producing a waterproof construction, the method comprising a step of applying a topcoat onto a coating formed by curing the multi-component type curable composition according to claim 1.
